(19) United States
(12) Patent Application Publication
(10) Pub. No.: US 2016/0086207 A1
(43) Pub. Date: Mar. 24, 2016

(54) INFORMATION PROCESSING APPARATUS, TERMINAL DEVICE, INFORMATION PROCESSING METHOD, AND NON-TRANSITORY COMPUTER READABLE STORAGE MEDIUM

(71) Applicant: YAHOO JAPAN CORPORATION, Tokyo (JP)

(72) Inventor: Akira TAJIMA, Tokyo (JP)

(21) Appl. No.: 14/850,569

(22) Filed: Sep. 10, 2015

(30) Foreign Application Priority Data
Sep. 19, 2014 (JP) 2014-191793

(51) Int. Cl. G06Q 30/02; G06F 17/30

(52) U.S. Cl. CPC G06Q 30/0204; G06F 17/30867; G06F 17/30598

(57) ABSTRACT

An information processing apparatus according to an embodiment includes an acquiring unit, a determining unit, and a distribution unit. The acquiring unit acquires information on applications installed in a terminal device. The determining unit determines a user class of a user who owns the terminal device based on the information on the applications acquired by the acquiring unit and based on a user class stored in a storage unit in association with a predetermined application combination. The distribution unit distributes an advertising content to the terminal device in accordance with the determined user class of the user who owns the terminal device.

### CROSS-REFERENCE TO RELATED APPLICATION(S)

The present application claims priority to and incorporates by reference the entire contents of Japanese Patent Application No. 2014-191793 filed in Japan on Sep. 19, 2014.

### BACKGROUND OF THE INVENTION

1. Field of the Invention

The present invention relates to an information processing apparatus, a terminal device, an information processing method, and a non-transitory computer readable storage medium.

2. Description of the Related Art

In recent years, smart devices, such as smartphones and tablet terminals, are in widespread use. Users using the smart devices are increasingly acquiring information by using applications installed in the smart devices, instead of acquiring information by using web browsers. In this case, cookies are different depending on applications. Therefore, it is difficult to specify a user by using the cookies and it is difficult to distribute a content suitable for each user.

Therefore, a technology for specifying a user without using cookies has been proposed. As this technology, for example, there has been proposed a technology for determining the similarity of users based on software (application) operation histories.

However, in the conventional technology as described above, it is not always possible to appropriately determine a user class of a user. For example, an increase in the number of applications available to a user makes it difficult to appropriately determine a user class of the user based on an application operation history.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a distribution process according to a first embodiment;

FIG. 2 is a diagram illustrating a configuration example of an information processing apparatus according to the first embodiment;

FIG. 3 is a diagram illustrating an example of a user information storage unit according to the first embodiment;

FIG. 4 is a diagram illustrating an example of a user class information storage unit according to the first embodiment;

FIG. 5 is a diagram illustrating an example of an advertising content storage unit according to the first embodiment;

FIG. 6 is a sequence diagram illustrating the flow of the distribution process according to the first embodiment;

FIG. 7 is a diagram illustrating an example of a user class information storage unit according to a modification;

FIG. 8 is a diagram illustrating an example of the user class information storage unit according to the modification;

FIG. 9 is a diagram illustrating an example of conversion to a hash value according to the modification;

FIGS. 10A and 10B are diagrams illustrating an example of low-rank approximation according to the modification;

FIG. 11 is a diagram illustrating an example of the low-rank approximation according to the modification;

FIG. 12 is a diagram illustrating an example of a distribution process according to a second embodiment;

FIG. 13 is a diagram illustrating a configuration example of a terminal device according to the second embodiment;

FIG. 14 is a diagram illustrating an example of an application storage unit according to the second embodiment;

FIG. 15 is a diagram illustrating an example of a user class information storage unit according to the second embodiment;

FIG. 16 is a sequence diagram illustrating the flow of the distribution process according to the second embodiment; and

FIG. 17 is a hardware configuration diagram illustrating an example of a computer that implements functions of the information processing apparatus.

### DETAILED DESCRIPTION OF THE PREFERRED EMBODIMENTS

Hereinafter, modes (hereinafter, referred to as “embodiments”) for carrying out an information processing apparatus, an information processing method, and an information processing program according to the present application will be described in detail with reference to the accompanying drawings. The information processing apparatus, the information processing method, and the information processing program according to the present application are not limited by the following embodiments. In the following embodiments, an example will be described, in which a distribution process of distributing an advertising content based on a list of applications installed in a terminal device is performed as information processing. In the following embodiments, the same components are denoted by the same reference numerals, and the same explanation will not be repeated.

### First Embodiment

1. Distribution Process

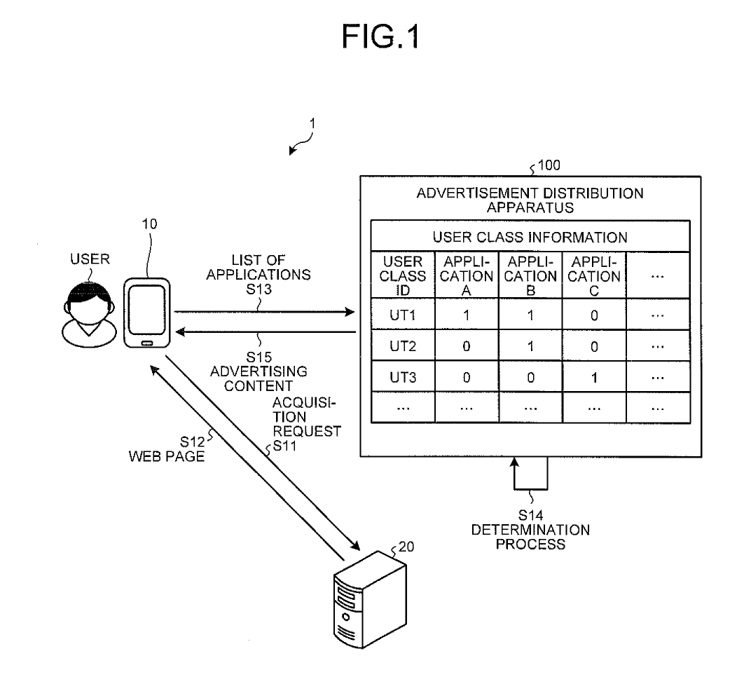

First, with reference to FIG. 1, an example of a distribution process according to a first embodiment will be described. FIG. 1 is a diagram illustrating an example of the distribution process according to the first embodiment. An advertisement distribution apparatus 100 illustrated in FIG. 1 provides a distribution service to distribute an advertising content to a terminal device 10 in accordance with a user class of a user determined based on a list of applications installed in the terminal device 10.

As illustrated in FIG. 1, a distribution system 1 includes the terminal device 10, a web server 20, and the advertisement distribution apparatus 100. The terminal device 10, the web server 20, and the advertisement distribution apparatus 100 are connected through a predetermined communication network (not illustrated) so as to communicate with one another by wire or wirelessly. The distribution system 1 illustrated in FIG. 1 may include a plurality of the terminal devices 10, a plurality of the web servers 20, and a plurality of the advertisement distribution apparatuses 100.

The terminal device 10 is an information processing apparatus used by a user. For example, the terminal device 10 acquires a web page from the web server 20 in accordance with an operation by the user. In the following, the terminal device 10 may be described as a user. That is, in the following, a user may be interpreted as the terminal device 10. The terminal device 10 as described above is realized by, for example, a smartphone, a tablet terminal, a notebook personal computer (PC), a desktop PC, a mobile phone, a personal digital assistant (PDA), or the like.

The web server 20 is an information processing apparatus that distributes a web page to the terminal device 10. For example, the web server 20 distributes various web pages related to news sites, auction sites, weather report sites, shopping sites, finance (stock price) sites, route search sites, map sites, travel sites, restaurant sites, weblogs, and the like.

The web page distributed by the web server 20 is generated with a Hyper Text Markup Language (HTML) file written by HTML or an Extensible Markup Language (XML) file written by XML, for example. The web page distributed by the web server 20 includes control information for controlling a display mode of the web page and an advertising content. The control information is written in the HTML file or the like of the web page in a script language, such as JavaScript (registered trademark) or Cascading Style Sheets (CSS).

The web page distributed by the web server 20 further includes an advertising acquisition command. For example, in the HTML file or the like of the web page, a URL of the advertisement distribution apparatus 100 or the like is written as the advertising acquisition command. In this case, the terminal device 10 accesses the URL written in the HTML file or the like, thereby acquiring an advertising content from the advertisement distribution apparatus 100. Various kinds of data distributed from the web server 20 to the terminal device 10 are actually HTML files, images, and the like of the web page. In the following, various kinds of data distributed from the web server 20 to the terminal device 10 may be described as a “web page”.

The advertisement distribution apparatus 100 is an information processing apparatus that provides a distribution service to distribute an advertising content to the terminal device 10 in accordance with the user class of the user determined based on the list of the applications installed in the terminal device 10. For example, the advertisement distribution apparatus 100 determines a user class of a user who owns the terminal device 10 based on the list of the applications installed in the terminal device 10 and user class information. Here, the user class information includes a user class that is stored in a storage unit 120 in association with a predetermined combination of applications (hereinafter, may be simply referred to as an “application combination”). Further, the user class information includes association between each user class and a field in which it is estimated that a user belonging to the user class is likely to be interested (hereinafter, referred to as an “interested field”), for example. Details of the user class information will be described later. The advertisement distribution apparatus 100 distributes an advertising content corresponding to the determined user class of the user to the terminal device 10.

As illustrated in FIG. 1, when the user views a web page by using the terminal device 10, the terminal device 10 transmits a web page acquisition request to the web server 20 (Step S11). The web server 20 that has received the web page acquisition request from the terminal device 10 transmits, to the terminal device 10, a web page corresponding to the acquisition request received from the terminal device 10 (Step S12). If the web page contains an advertising acquisition command, the terminal device 10 that has received the web page from the web server 20 transmits, to the advertisement distribution apparatus 100, a list of applications installed in the terminal device 10 as an advertising request to acquire an advertising content (Step S13). The list of the applications described herein is information on the applications, and is information indicating whether or not an application corresponding to the application combination in the user class information is installed in the terminal device 10.

When acquiring the list of the applications from the terminal device 10, the advertisement distribution apparatus 100 performs a determination process of determining the user class of the user who owns the terminal device 10 (Step S14). Details of the determination process will be described later. The advertisement distribution apparatus 100 distributes an advertising content to the terminal device 10 in accordance with the determined user class of the user (Step S15). For example, when determining that the similarity between the user who owns the terminal device 10 and a user class associated with the field of vehicles as the interested field is high, the advertisement distribution apparatus 100 transmits an advertisement related to vehicles to the terminal device 10.

As described above, in the distribution system 1 according to the first embodiment, the advertisement distribution apparatus 100 determines the user class of the user who owns the terminal device 10 based on the user class information and the list of the applications, where the list of the application is the information on the installed applications and is acquired from the terminal device 10. Therefore, the advertisement distribution apparatus 100 can appropriately determine the user class of the user. The advertisement distribution apparatus 100 distributes, to the terminal device 10, an advertising content selected in accordance with the user class that is determined as having high similarity with the user who owns the terminal device 10. For example, if the interested field is associated with the user class, the advertisement distribution apparatus 100 can distribute, to the terminal device 10, an advertising content in which the user who owns the terminal device 10 is likely to be interested. Therefore, the advertisement distribution apparatus 100 can distribute an advertising content suitable for each user, so that the advertising effect can be improved. As described above, the advertisement distribution apparatus 100 can appropriately provide a service based on information on an application installed by a user even when a behavior history of the user is not collected or profile information on the user is not provided. That is, the distribution system 1 including the advertisement distribution apparatus 100 can perform advertising distribution and product recommendation (recommendation) suitable for a user even when a behavior history or profile information on the user is not acquired. Therefore, it is possible to address a problem (so-called cold start problem) in that it is difficult to appropriately perform advertising distribution and recommendation suitable for a user whose behavior history or profile information is not acquired. That is, the distribution system 1 can appropriately provide various services, such as advertising distribution and recommendation, to the user based on the information on the applications of the user, without acquiring the behavior history or the profile from the user.

Incidentally, what types of applications or how many applications are employed as a target, that is, a selection of applications to be included in the application combination or in the list of the applications may be changed appropriately depending on the purpose of a user class or the number of user classes to be classified. For example, the application combination or the list of the applications may include a thousand applications or a million applications. For another example, the application combination or the list of the applications may include applications used by a large number of users (for example, more than a million downloads) or applications used by only a small number of users (for example, less than ten thousands of downloads). It may be possible to use, as an ID, a hash value that is converted from an application process name through a predetermined hash function, and use an application combination or a list of applications including an application corresponding to the ID. The terminal device 10 may transmit, to the advertisement distribution apparatus 100, a name of a running process as the information on an installed application. The user class may be a user class based on a behavior history of a user. In this case, the advertisement distribution apparatus 100 generates the user class based on the behavior history acquired from an identifiable user. The identifiable user described herein includes various users who can be identified by the advertisement distribution apparatus 100, such as a user who can be identified by a login ID for a specific service or a user who accepts collection of a behavior history. The advertisement distribution apparatus 100 may generate the user class and the application combination based on information on applications acquired from a user who has logged in a predetermined service or a user who has accepted collection of a behavior history, for example. As for such a user, it is possible to acquire information on the behavior history in addition to the information on the applications; therefore, the user class based on the information on the applications of the user is a user class modeled based on the facts such as behaviors of the user. Therefore, it is possible to estimate a behavioral tendency of the user who is classified based on the user class as described above, in such a manner that, for example, the user is likely to be interested in a content Y because the user has installed a predetermined application X. That is, when the user class is determined based on the user class modeled based on the behavior history, it becomes possible to determine how the user is likely to behave.

In the above-described processes, an example is described in which the advertisement distribution apparatus 100 acquires the list of the applications as the information on applications. However, the advertisement distribution apparatus 100 may acquire, as the information on applications, information on whether or not each of the applications is installed or information on whether or not some of the applications are installed. In this case, the advertisement distribution apparatus 100 may generate the list of the applications corresponding to the user who owns the terminal device 10, from the acquired information on the applications installed in the terminal device 10. For example, the advertisement distribution apparatus 100 may acquire the information on the installed applications from the terminal device 10 at predetermined intervals (for example, every other day). In this case, the terminal device 10 may transmit the advertising request to the advertisement distribution apparatus 100 at Step S13. The advertisement distribution apparatus 100 generates a list of applications from the information that is about the applications installed in the terminal device 10 and that is acquired at predetermined intervals, and performs the processes at Steps S14 and S15 based on the generated list of the applications. Incidentally, if the advertisement distribution apparatus 100 acquires installation or non-installation of applications when a user uses the applications, the advertisement distribution apparatus 100 may estimate the user from an Internet Protocol (IP) address of the terminal device 10, a version of an operating system (OS) of the terminal device 10, a current location of the terminal device 10, or the like, and generate a list of applications by integrating pieces of information on the applications estimated as the same user.

2. Configuration of Information Processing Apparatus

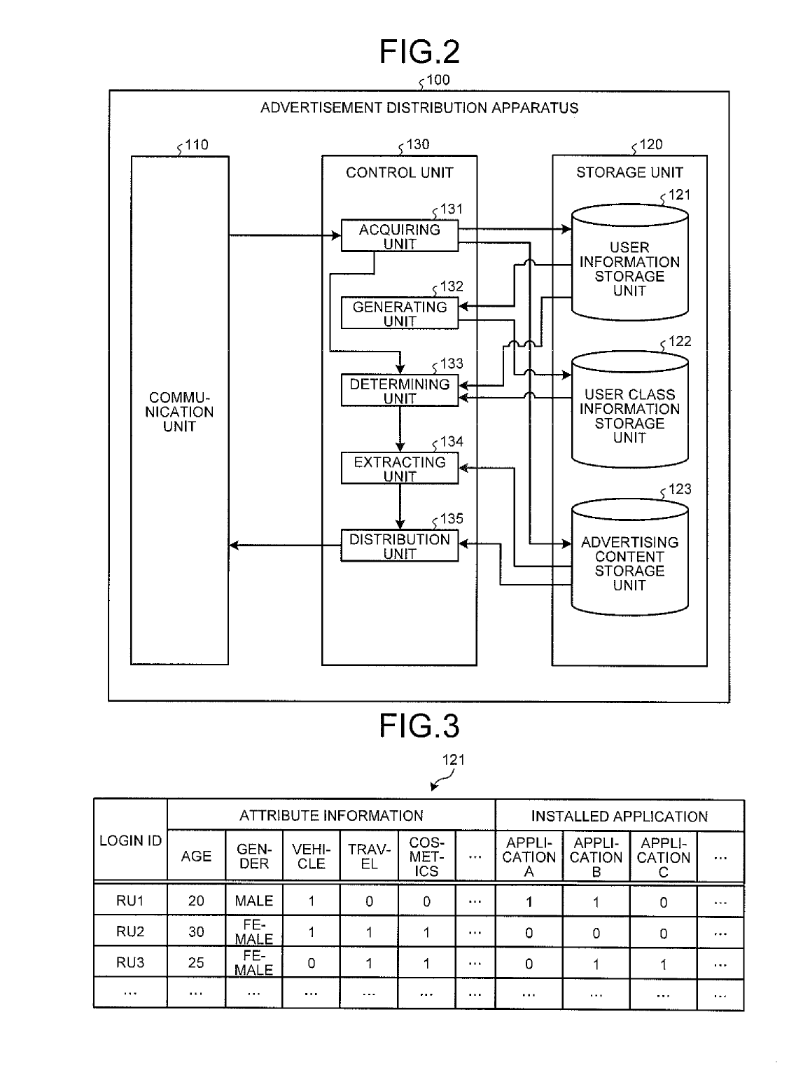

Next, with reference to FIG. 2, a configuration of the advertisement distribution apparatus 100 according to the first embodiment will be described. FIG. 2 is a diagram illustrating a configuration example of the advertisement distribution apparatus 100 according to the embodiment. As illustrated in FIG. 2, the advertisement distribution apparatus 100 includes a communication unit 110, the storage unit 120, and a control unit 130. The advertisement distribution apparatus 100 may include an input unit (for example, a keyboard, a mouse, or the like) for receiving various operations from an administrator or the like of the advertisement distribution apparatus 100, or a display unit (for example, a liquid crystal display or the like) for displaying various kinds of information.

Communication Unit 110

The communication unit 110 is realized by, for example, a network interface card (NIC). The communication unit 110 is connected to a predetermined communication network (not illustrated) by wire or wirelessly. The communication unit 110 transmits and receives information to and from the terminal device 10 via the predetermined communication network (not illustrated).

Storage Unit 120

The storage unit 120 is realized by, for example, a semiconductor memory device such as a random access memory (RAM) or a flash memory, or a storage device such as a hard disk or an optical disk. The storage unit 120 according to the first embodiment includes, as illustrated in FIG. 2, a user information storage unit 121, a user class information storage unit 122, and an advertising content storage unit 123.

User Information Storage Unit 121

The user information storage unit 121 according to the first embodiment stores therein attribute information on a user and information on applications installed in a terminal device of the user. FIG. 3 illustrates an example of information on the attribute information on a user and the information on applications stored in the user information storage unit 121. As illustrated in FIG. 3, the user information storage unit 121 includes, as information on a user, items of “login ID”, “attribute information”, and “installed application”.

The “login ID” indicates identification information for identifying a user. For example, the login ID indicates identification information for identifying a user who logs in a predetermined service to receive the service. The “attribute information” includes various kinds of information on a user, such as a demographic attribute and a psychographic attribute. The “installed application” indicates information on applications installed in a terminal device of the user identified by the login ID.

The “attribute information” includes items of “age” and “gender” that are pieces of information on the demographic attribute, and items of “vehicle”, “travel”, “cosmetics”, . . . that are pieces of information on the psychographic attribute. For example, the user information storage unit 121 stores therein the age of “20” and the gender of “male” for a user identified by a login ID of “RU1”. Meanwhile, the user information storage unit 121 may store therein, as the “attribute information”, pieces of information on the demographic attribute, such as an occupation, a family structure, an annual income, a hometown, and an academic background, of the user.

As illustrated in FIG. 3, as to which of fields such as “vehicle”, “travel”, “cosmetics” . . . attracts interest, in the user information storage unit 121, it may be possible to store “1” for a field in which a user is interested and store “0” for a field in which a user is not interested. In the example illustrated in FIG. 3, in the user information storage unit 121, “1” is set for “vehicle”, “0” is set for “travel”, “0” is set for “cosmetics”, . . . for the user identified by the login ID of “RU1”. That is, the user information storage unit 121 stores information indicating that the user identified by the login ID of “RU1” is interested in vehicles but is not interested in travel and cosmetics. The advertisement distribution apparatus 100 may automatically extract the above-described information stored in the user information storage unit 121 from a behavior history that is acquired when a user logs in a predetermined service, or the advertisement distribution apparatus 100 may acquire the information through input from a user. For example, the advertisement distribution apparatus 100 may receive input of attribute information on a user when the user generates an account for a predetermined service, and acquire information on the gender, the age, and interested fields of the user.

The “installed application” indicates information on whether or not a predetermined application is installed in a terminal device of a user identified by the login ID. The “installed application” includes items of “application A”, “application B”, “application C”, . . . . Herein, each of the “application A”, the “application B”, the “application C”, . . . corresponds to a specific application. For example, the “application A” is a specific game application, the “application B” is a specific news application, and the “application C” is a specific mail-order application.

The “application A” indicates whether or not the application A is installed. For example, the user information storage unit 121 stores therein “1” when the application A is installed, and stores therein “0” when the application A is not installed. In the example illustrated in FIG. 3, the user identified by the login ID of “RU1” has installed the application A, and users identified by the login ID of “RU2” and the login ID of “RU3” have not installed the application A.

The “application B” indicates whether or not the application B is installed. For example, the user information storage unit 121 stores therein “1” when the application B is installed, and stores therein “0” when the application B is not installed. In the example illustrated in FIG. 3, the users identified by the login ID of “RU1” and the login ID of “RU3” have installed the application B, and the user identified by the login ID of “RU2” has not installed the application B.

Similarly, the “application C” indicates whether or not the application C is installed. For example, the user class information storage unit 122 stores therein “1” when the application C is installed, and stores therein “0” when the application C is not installed. In the example illustrated in FIG. 3, the users identified by the login ID of “RU1” and the login ID of “RU2” have not installed the application C, and the user identified by the login ID of “RU3” has installed the application C.

As described above, the user information storage unit 121 stores therein the information on applications, which is acquired from a user who is identifiable by the login ID, in association with the attribute information on the user. Incidentally, the user class and the application combination included in the user class information are generated based on the attribute information and the information on applications on the user who is identifiable by the login ID stored in the user information storage unit 121, which will be described in detail later.

User Class Information Storage Unit 122

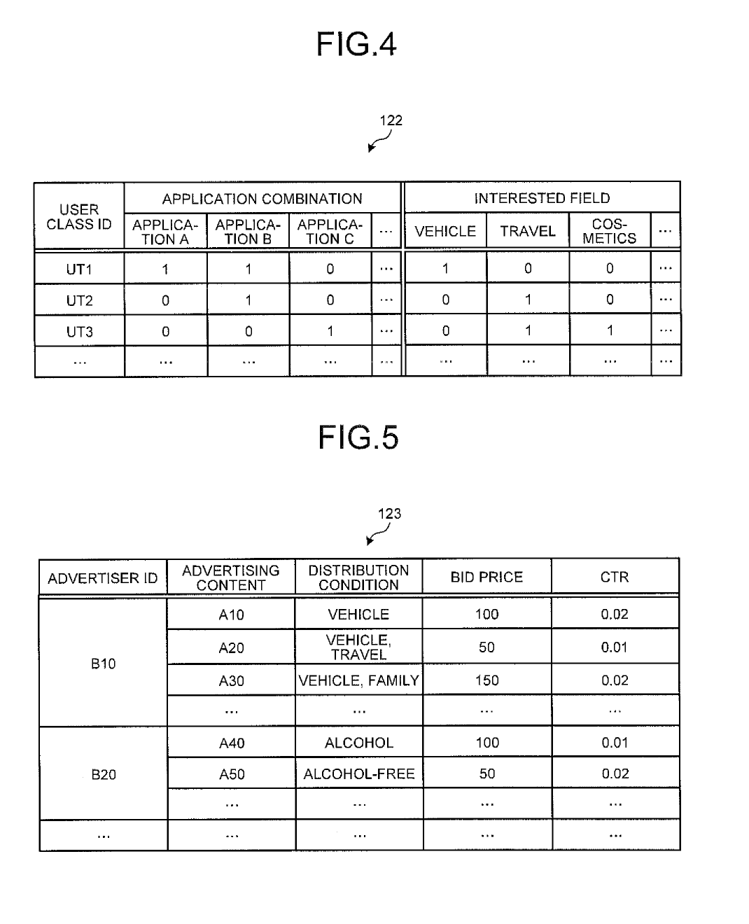

The user class information storage unit 122 according to the first embodiment stores therein information on a user class. FIG. 4 illustrates an example of the information on the user class stored in the user class information storage unit 122. As illustrated in FIG. 4, the user class information storage unit 122 includes, as the information on the user class, items of “user class ID”, “application combination”, and “interested field”.

The “user class ID” indicates identification information for identifying a plurality of user classes for classifying users. For example, the user class ID indicates identification information for identifying a plurality of user classes for classifying users based on application combinations. In the example illustrated in FIG. 4, a user class identified by a user class ID of “UT1” is a user class of a user whose interested field corresponds to the field of vehicles and the like, a user class identified by a user class ID of “UT2” is a user class of a user whose interested field corresponds to the field of travel and the like, a user class identified by a user class ID of “UT3” is a user class of a user whose interested field corresponds to the field of travel, the field of cosmetics, and the like, . . . . Hereinafter, the user class identified by the user class ID of “UT1” may be referred to as the user class ID “UT1”. The same applies to the other user class IDs of “UT2”, “UT3”, . . . .

The “application combination” indicates information on whether or not a predetermined application is installed in a terminal device of a user belonging to the user class identified by the user class ID. The “application combination” includes items of “application A”, “application B”, “application C”, . . . . Herein, each of the “application A”, the “application B”, the “application C”, . . . corresponds to a specific application. For example, the “application A” is a specific game application, the “application B” is a specific news application, and the “application C” is a specific mail-order application. Therefore, the user class information storage unit 122 stores therein a plurality of user classes for classifying users and a plurality of specific application combinations in an associated manner. In other words, the advertisement distribution apparatus 100 classifies users into a plurality of user classes based on combinations of installation and non-installation of applications.

The “application A” indicates whether or not the application A is installed. For example, the user class information storage unit 122 stores therein “1” when the application A is installed, and stores therein “0” when the application A is not installed. In the example illustrated in FIG. 4, a user class identified by the user class ID “UT1” has installed the application A, and user classes identified by the user class ID “UT2” and the user class ID “UT3” have not installed the application A. In other words, users with the user class ID “UT1” are likely to have installed the application A, and users with the user class ID “UT2” and the user class ID “UT3” are less likely to have installed the application A.

The “application B” indicates whether or not the application B is installed. For example, the user class information storage unit 122 stores therein “1” when the application B is installed, and stores therein “0” when the application B is not installed. In the example illustrated in FIG. 4, the user classes identified by the user class ID “UT1” and the user class ID “UT2” have installed the application B, and the user class identified by the user class ID “UT3” has not installed the application B.

Similarly, the “application C” indicates whether or not the application C is installed. For example, the user class information storage unit 122 stores therein “1” when the application C is installed, and stores therein “0” when the application C is not installed. In the example illustrated in FIG. 4, the user classes identified by the user class ID “UT1” and the user class ID “UT2” have not installed the application C, and the user class identified by the user class ID “UT3” has installed the application C.

In the “interested field”, information on an interested field of the user class identified by the user class ID is stored. The “interested field” includes items of “vehicle”, “travel”, “cosmetics”, . . . . For example, it may be possible to store “1” for a field in which it is estimated that a user belonging to the user class identified by the user class ID is likely to be interested, and store “0” for other fields. In the example illustrated in FIG. 4, in the user class information storage unit 122, “1” is set for “vehicle”, “0” is set for “travel”, “0” is set for “cosmetics”, . . . for a user belonging to the user class identified by the user class ID of “UT1”. That is, the user class information storage unit 122 stores information indicating that a user belonging to the user class identified by the user class ID “UT1” is interested in vehicles but is not interested in travel and cosmetics.

As described above, the user class information storage unit 122 stores therein the user class for classifying users and the application combination in an associated manner. That is, a plurality of the user classes stored in the user class information storage unit 122 indicate classifications of users based on combinations of installation and non-installation of applications. Further, the user class information storage unit 122 stores therein each user class ID and the interested field of the user class identified by the user class ID in an associated manner.

The advertisement distribution apparatus 100 may generate the user class information to be stored in the user class information storage unit 122 on the basis of information acquired from a user who has logged in a predetermined service. For example, the advertisement distribution apparatus 100 generates the user class information based on the information stored in the user information storage unit 121, which will be described in detail later. The advertisement distribution apparatus 100 may store, in the user class information storage unit 122, user class information input by the administrator or the like of the advertisement distribution apparatus 100, and use the user class information.

Advertising Content Storage Unit 123

The advertising content storage unit 123 according to the first embodiment stores therein various kinds of information on advertising contents. FIG. 5 illustrates an example of the advertising content storage unit 123 according to the first embodiment. The advertising content storage unit 123 illustrated in FIG. 5 includes items of “advertiser ID”, “advertising content”, “distribution condition”, “bid price”, and “click-through rate (CTR)”.

The “advertiser ID” indicates identification information for identifying an advertiser. The “advertising content” indicates an advertising content submitted by the advertiser. In FIG. 5, an example is illustrated in which conceptual information such as “A10” is stored in the “advertising content”. However, in reality, a still image, a moving image, text data, a URL, or a file path name indicating a storage location of the still image, the moving image, the text data, or the URL is stored.

The “distribution condition” indicates a condition for distributing each advertising content. For example, the advertising content of “A10” indicates an advertising content that is distributed when a distribution condition of “vehicle” is satisfied. In the example illustrated in FIG. 5, the advertising content of “A10” is an advertisement related to a vehicle, and may be distributed when a user who has requested an advertisement is a user in the user class whose interested field corresponds to the field of vehicles. For another example, an advertising content of “A20” indicates an advertising content that is distributed when distribution conditions of “vehicle” and (or) “travel” are satisfied. Meanwhile, the distribution condition may include attribute information on the user (for example, “twenty-something male” or the like).

The “bid price” indicates an advertising fee that is specified by an advertiser at the time of submission of an advertising content. For example, the “bid price” corresponds to a unit price to be paid from the advertiser to an advertising distributor (for example, the administrator of the advertisement distribution apparatus 100) when the advertising content is clicked once by a user. In the embodiment, the “bid price” may be a unit price to be paid from the advertiser to the advertising distributor when a user performs a specifying operation once.

The “CTR” indicates a value obtained by dividing the number of clicks on an advertising content by the number of displays of the advertising content. As the CTR of an advertising content that has never been distributed to a terminal device, a predetermined fixed value, an average of CTRs of all of advertising contents, an average of CTRs of all of advertising contents belonging to the same advertisement category (for example, vehicle or travel), or the like may be stored. Further, a predicted CTR that is predicted from a CTR prediction model or the like may be stored in the “CTR”. The predicted CTR as described above is predicted by, for example, a type of the advertising content or a type of a web page on which the advertising content is displayed. Specifically, in FIG. 5, an example is illustrated in which an advertiser identified by an advertiser ID of “B10” specifies a bid price of “100” and submits the advertising content of “A10”. Further, in FIG. 5, an example is illustrated in which the CTR of the advertising content of “A10” is “0.02”.

Control Unit 130

Referring back to FIG. 2, the control unit 130 is realized, for example, by executing various programs (corresponding to an example of an information processing program) stored in a storage device in the advertisement distribution apparatus 100 by a central processing unit (CPU), a micro processing unit (MPU), or the like by using a RAM as a work area. Further, the control unit 130 is realized by an integrated circuit, such as an application specific integrated circuit (ASIC) or a field programmable gate array (FPGA).

As illustrated in FIG. 2, the control unit 130 includes an acquiring unit 131, a generating unit 132, a determining unit 133, an extracting unit 134, and a distribution unit 135, and realizes or implements functions and operations of a distribution process as described later. The internal configuration of the control unit 130 is not limited to the configuration illustrated in FIG. 2, and other configurations may be employed as long as the distribution process to be described later is performed. Further, the connection relation of the processing units of the control unit 130 is not limited to the connection relation illustrated in FIG. 2, and other connection relations may be employed.

Acquiring Unit 131

The acquiring unit 131 acquires information on an advertising content from an advertiser. That is, the acquiring unit 131 receives submission of an advertising content from an advertiser. Further, the acquiring unit 131 stores the advertising content received from the advertiser in the advertising content storage unit 123. The acquiring unit 131 may receive a distribution condition on the advertising content, together with the advertising content.

When acquiring information on applications of an identifiable user, the acquiring unit 131 stores the information on applications in the user information storage unit 121 in association with the attribute information on the identifiable user stored in the user information storage unit 121. For example, the acquiring unit 131 stores, in the user information storage unit 121, information on applications of a user who is identifiable by the login ID upon login to a predetermined service by the user, in association with the attribute information on the user. Furthermore, the acquiring unit 131 may acquire a behavior history from a terminal device of a user who has logged in a predetermined service. Moreover, the acquiring unit 131 may acquire input as to the attribute information from a user.

Furthermore, the acquiring unit 131 acquires a list of applications as the information on applications installed in the terminal device 10. The acquiring unit 131 acquires, as the list of the applications, the same information as the application combination indicating whether or not the application A is installed, whether or not the application B is installed, whether or not the application C is installed, . . . . For example, the acquiring unit 131 acquires the list of the applications in such a format that “1” is set when the application A is installed, “0” is set when the application B is not installed, “1” is set when the application C is installed, . . . . Incidentally, the acquiring unit 131 may acquire, as the information on applications, information on whether or not each of the applications is installed or whether or not some of the applications are installed. Furthermore, the acquiring unit 131 may acquire the information on the installed applications from the terminal device 10 at predetermined intervals (for example, every other day). In this case, for example, the acquiring unit 131 may store, in the user information storage unit 121, information that is about the applications installed in the terminal device 10 and that is acquired from the terminal device 10.

Generating Unit 132

The generating unit 132 generates a user class and an application combination based on the attribute information and the information on applications on an identifiable user stored in the user information storage unit 121. The generating unit 132 stores the generated user class and the generated application combination in the user class information storage unit 122. For example, the generating unit 132 may generate a single user class and application combination based on the attribute information and the information on applications on a single identifiable user stored in the user information storage unit 121. Further, the generating unit 132 may generate a single user class and application combination based on pieces of the attribute information and pieces of the information on applications on a plurality of identifiable users stored in the user information storage unit 121. The generating unit 132 associates the generated user class with an interested field that is estimated from the attribute information on the identifiable user. Further, the generating unit 132 may generate a user class and a predetermined application combination based on the behavior history and the information on applications on an identifiable user acquired by the acquiring unit 131. For example, the user class and the application combination may be generated based on the information on applications acquired from an identifiable user, such as a user who has logged in a predetermined service or a user who has accepted collection of a behavior history. As for such a user, it is possible to acquire information on the behavior history in addition to the information on applications; therefore, a user class based on the information on applications on the user is a user class modeled based on the facts such as the behaviors of the user. That is, when the determining unit 133 determines a user class based on the user class modeled based on the behavior history as described below, it becomes possible to determine how the user is likely to behave.

The application combination may be generated based on the user's “installed application” that is a basis for the user class and that is stored in the user information storage unit 121. For example, the generating unit 132 may generate a single application combination based on installed applications of a single identifiable user stored in the user information storage unit 121. Further, the generating unit 132 may generate a single application combination based on installed applications of a plurality of identifiable users stored in the user information storage unit 121. Incidentally, the interested field may be generated from the user's attribute information that is a basis for the user class and that is stored in the user information storage unit 121, and may be associated with the user class.

Determining Unit 133

The determining unit 133 performs a determination process of determining the user class of the user who owns the terminal device 10 based on the list of the applications that the acquiring unit 131 acquires from the terminal device 10 and based on the user class that is stored in the user class information storage unit 122 in association with the application combination. Incidentally, if the acquiring unit 131 acquires an advertising request from the terminal device 10, the determining unit 133 may perform the determination process on the basis of the information on the applications installed in the terminal device 10, where the information on the applications is stored in the user information storage unit 121. The determination process will be described in detail below.

For example, when there is a user class for which the list of the applications, which is the information on applications acquired from the terminal device 10, and the application combination match each other, the determining unit 133 determines that the user who owns the terminal device 10 corresponds to this user class. Specifically, when the list of the applications acquired from the terminal device 10 and the application combination of the user class ID “UT1” match each other, the determining unit 133 may determine that the user who owns the terminal device 10 corresponds to the user class ID “UT1”. Herein, match between the list of the applications and the application combination means that, for example, an array of “0” and “1” in the list of the applications and an array of “0” and “1” in the application combination are the same. Incidentally, in this case, the list of the applications and the application combination are arrays of pieces of information indicating installation or non-installation of applications in the same order, for example, in order of the “application A”, the “application B”, the “application C”, . . . . That is, the list of the applications and the application combination have the same information of “0” (or “1”) as to installation or non-installation of the same application, and do not include an application whose value is different.

Further, the determining unit 133 may determine that the user who owns the terminal device 10 belongs to a user class for which the list of the applications and the application combination most closely approximate each other. Herein, the closest approximation between the list of the applications and the application combination means that, for example, the number of differences between the array of “0” and “1” in the list of the applications and the array of “0” and “1” in the application combination is small. Specifically, the determining unit 133 may determine that they approximate each other when the total number of portions in each of which “0” is set in the list of the applications while “1” is set in the application combination and portions in each of which “1” is set in the list of the applications while “0” is set in the application combination is small. Therefore, the determining unit 133 may determine that the user who owns the terminal device 10 belongs to a user class corresponding to the application combination for which the above-described total number (that is, the number of portions in which different values are set for the same applications) is small. Incidentally, the determining unit 133 may determine that a single user belongs to a plurality of user classes.

Extracting Unit 134

When the acquiring unit 131 acquires the list of the applications or the advertising request from the terminal device 10, the extracting unit 134 extracts an advertising content, which is to be distributed, from the advertising content storage unit 123 on the basis of the interested field of the user class of the user who owns the terminal device 10, where the user class is determined by the determining unit 133. For example, the extracting unit 134 extracts an advertising content with a distribution condition corresponding to the interested field of the user class. Specifically, if it is determined that the similarity between the user who owns the terminal device 10 and the user class identified by the user class ID “UT1” is the highest, the extracting unit 134 extracts an advertising content for which “vehicle” is set in the item of “distribution condition” in the advertising content storage unit 123. In the example illustrated in FIG. 5, the extracting unit 134 extracts a plurality of advertising contents “A10”, “A20”, “A30”, . . . for which “vehicle” is set in the item of “distribution condition”. Incidentally, the extracting unit 134 may extract an advertising content for which only “vehicle” is set in the item of “distribution condition”. In this case, the extracting unit 134 extracts the advertising content “A10” . . . . Further, the extracting unit 134 may extract an advertising content with the highest bid price among the advertising contents for which “vehicle” is set in the item of “distribution condition”. Furthermore, the extracting unit 134 may extract an advertising content with the highest CTR among the advertising contents for which “vehicle” is set in the item of “distribution condition”. Moreover, the extracting unit 134 may preferentially extract an advertising content with a high bid price or a high CTR or an advertising content with a high bid price and a high CTR among the advertising contents stored in the advertising content storage unit 123.

Distribution Unit 135

The distribution unit 135 distributes an advertising content stored in the advertising content storage unit 123. Specifically, the distribution unit 135 distributes, to the terminal device 10 that has transmitted the advertising request, the advertising content extracted by the extracting unit 134. When the extracting unit 134 extracts a plurality of advertising contents, the distribution unit 135 may distribute an advertising content selected based on a predetermined criterion. For example, the distribution unit 135 may distribute an advertising content that is least distributed among the plurality of the advertising contents extracted by the extracting unit 134. Further, the distribution unit 135 may distribute an advertising content randomly selected from among the plurality of the advertising contents extracted by the extracting unit 134.

3. Flow of Distribution Process

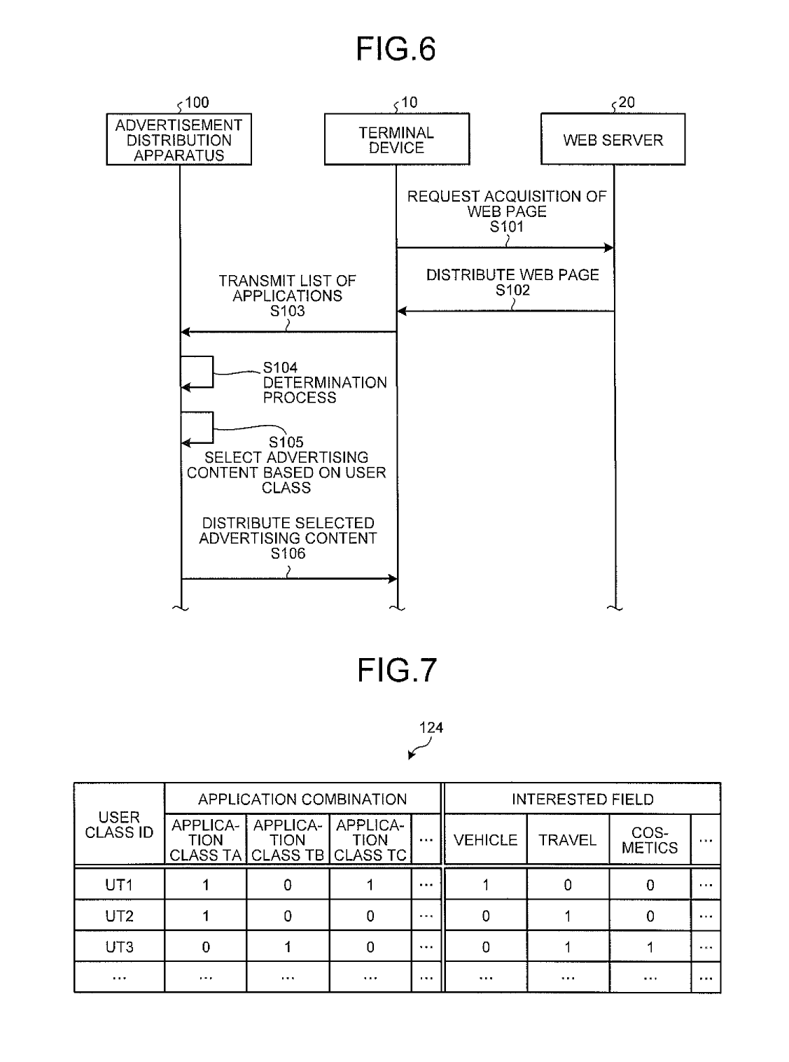

Next, with reference to FIG. 6, the flow of a distribution process performed by the distribution system 1 according to the first embodiment will be described. FIG. 6 is a sequence diagram illustrating the flow of the distribution process performed by the distribution system 1 according to the first embodiment.

As illustrated in FIG. 6, the terminal device 10 transmits a web page acquisition request to the web server 20 in accordance with a user operation (Step S101). The web server 20 distributes a web page to the terminal device 10 in response to the web page acquisition request (Step S102). The web page distributed by the web server 20 includes an advertising acquisition command, such as a URL of the advertisement distribution apparatus 100.

Subsequently, the terminal device 10 transmits an advertising content acquisition request to the advertisement distribution apparatus 100 on the basis of the advertising acquisition command included in the web page. For example, the terminal device 10 transmits, as an advertising request to request acquisition of an advertising content, the list of the applications installed in the terminal device 10 to the advertisement distribution apparatus 100 (Step S103).

When acquiring the list of the applications from the terminal device 10, the advertisement distribution apparatus 100 performs the determination process of determining the user class of the user who owns the terminal device 10, on the basis of the list of the applications acquired from the terminal device 10 and the user class associated with the application combination (Step S104). The advertisement distribution apparatus 100 selects an advertising content to be distributed, on the basis of the user class of the user who owns the terminal device 10, where the user class is determined at Step S104 (Step S105). Thereafter, the advertisement distribution apparatus 100 distributes the selected advertising content to the terminal device 10 (Step S106).

4. Modification

The distribution system 1 according to the first embodiment as described above may be embodied in various different forms other than the above-described first embodiment. Therefore, other embodiments of the above-described distribution system 1 will be described below.

4-1. Combination of Application Classes

In the above-described first embodiment, the advertisement distribution apparatus 100 performs the distribution process by using a specific application combination as the application combination in the user class information. However, the advertisement distribution apparatus 100 may perform the distribution process by using, as the application combination in the user class information, an application class for classifying applications. This will be described below with reference to FIG. 7. FIG. 7 is a diagram illustrating an example of a user class information storage unit 124 according to a modification.

The user class information storage unit 124 illustrated in FIG. 7 will be described below. As illustrated in FIG. 7, the user class information storage unit 124 includes, as information on a user class, items of “user class ID”, “application class TA”, “application class TB”, “application class TC”, . . . .

The “user class ID” indicates identification information for identifying a plurality of user classes for classifying users. For example, the user class ID indicates identification information for identifying a plurality of user classes for classifying users based on fields in which it is estimated that users are likely to be interested. In the example illustrated in FIG. 7, a user class identified by the user class ID “UT1” is a user class of a user whose interested field corresponds to the field of vehicles and the like, a user class identified by the user class ID “UT2” is a user class of a user whose interested field corresponds to the field of travel and the like, a user class identified by the user class ID “UT3” is a user class of a user whose interested field corresponds to the field of travel, the field of cosmetics, and the like, . . . .

Herein, the “application class TA”, the “application class TB”, the “application class TC”, . . . correspond to application classes obtained by classifying applications based on contents. For example, the “application class TA” is an application class to which an application related to news belongs, the “application class TB” is an application class to which an application related to shopping belongs, and the “application class TC” is an application class to which an application related to games belongs. Therefore, the user class information storage unit 124 stores therein each user class for classifying users, in association with a combination of applications classes. In other words, the advertisement distribution apparatus 100 determines a user class of a user based on a combination of installation and non-installation of applications belonging to an application class.

The “application class TA” indicates whether or not an application belonging to the application class TA is installed. For example, the user class information storage unit 124 stores therein “1” when an application related to news is installed, and stores therein “0” when an application related to news is not installed. In the example illustrated in FIG. 7, the user class ID “UT1” and the user class ID “UT2” have installed applications related to news, and the user class ID “UT3” has not installed an application related to news. In other words, a user with the user class ID “UT1” and a user with the user class ID “UT2 are likely to have installed applications related news, and a user with the user class ID “UT3” is less likely to have installed applications related to news.

The “application class TB” indicates whether or not an application belonging to the application class TB is installed. For example, the user class information storage unit 124 stores therein “1” when an application related to shopping is installed, and stores therein “0” when an application related to shopping is not installed. In the example illustrated in FIG. 7, the user class ID “UT1” and the user class ID “UT2” have not installed applications related to shopping, and the user class ID “UT3” has installed an application related to shopping.

Similarly, the “application class TC” indicates whether or not an application belonging to the application class TC is installed. For example, the user class information storage unit 124 stores therein “1” when an application related to games is installed, and stores therein “0” when an application related to games is not installed. In the example illustrated in FIG. 7, the user class ID “UT1” has installed an application related to games, and the user class ID “UT2” and the user class ID “UT3” have not installed applications related to games.

In this manner, the user class information storage unit 124 stores therein each of the user classes for classifying users, in association with a combination of installation and non-installation of applications belonging to a predetermined application class. That is, the user class stored in the user class information storage unit 124 indicates a user class based on the combination of installation and non-installation of the applications belonging to the predetermined application class. Further, the user class information storage unit 124 stores therein each user class ID in association with an interested field of the user class identified by the user class ID.

In this case, the determining unit 133 performs the determination process based on the user class associated with a combination of application classes. Therefore, the determining unit 133 derives a list of applications indicating installation and non-installation of applications belonging to a predetermined application class from the list of the installed applications acquired from the terminal device 10. For example, the determining unit 133 derives a list indicating installation and non-installation of applications belonging to an application class from the list of the installed applications acquired from the terminal device 10, and performs the determination process by using the derived list as the list of the applications. Incidentally, the acquiring unit 131 may acquire, as the list of the applications, the list indicating installation and non-installation of the applications belonging to the application class from the terminal device 10.

4-2. Use of Hash Method

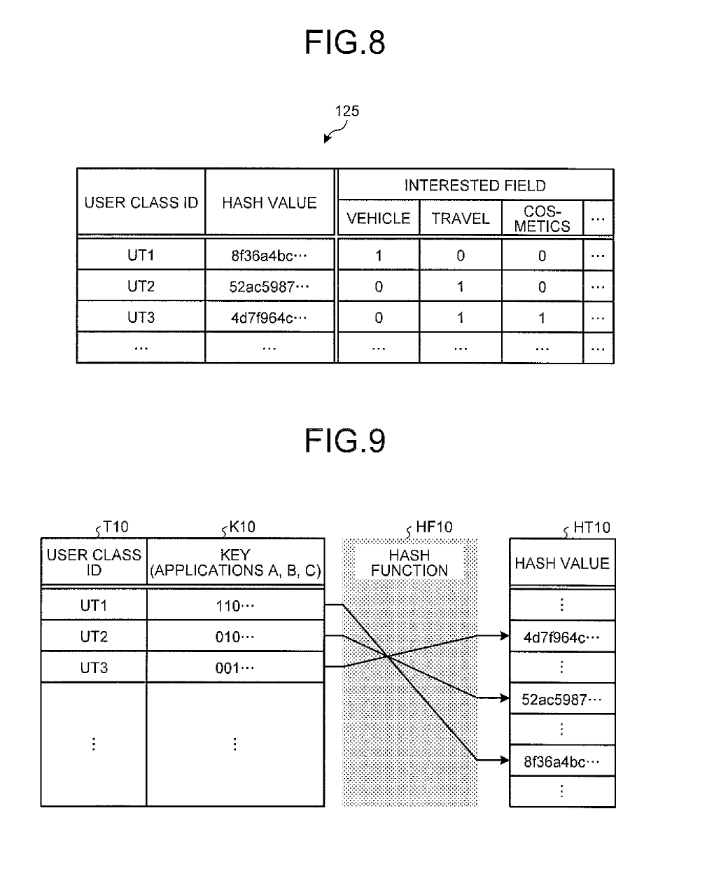

The advertisement distribution apparatus 100 may perform the determination process based on a user class associated with a hash value that is converted from the application combination through a predetermined hash method. For example, the advertisement distribution apparatus 100 determines the user class of the user who owns the terminal device 10, on the basis of a user class associated with a hash value that is converted from the application combination through a predetermined hash method. This will be described below with reference to FIG. 8 and FIG. 9. Incidentally, the application combination is information indicating presence or absence of each application, and is information, such as a binary value or a hexadecimal value, that can be treated in various formats. For example, in the case of a list of applications including “1” indicating that the application A is installed, “0” indicating that the application B is not installed, “1” indicating that the application C is installed, . . . , the application combination may be treated as a binary value “101 . . . ” or a 1-by-x matrix “[101 . . . ]”. FIG. 8 is a diagram illustrating an example of a user class information storage unit 125 according to the modification. The user class information storage unit 125 stores therein a hash value that is converted from the application combination, which is treated as a binary value, through a predetermined hash method. For example, the advertisement distribution apparatus 100 uses, as a hash method, locality-sensitive hashing (LSH), that is, a locality-sensitive hashing method. In the locality-sensitive hashing, a hash function is used such that hash values of pieces of similar data match each other while hash values of pieces of dissimilar data differ from each other. Therefore, by using the locality sensitive hashing method, it is expected that those corresponding to similar application combinations are converted to the same hash value.

With reference to FIG. 9, an example of conversion of the application combination of each user class to a hash value will be described below. A user class ID T10 (hereinafter, simply referred to as a “user class”) indicates each user class. A key K10 is an example of the application combination treated as a binary value for each user class. For example, in the example illustrated in FIG. 4, the user class ID “UT1” corresponds to “1” for the application A, “1” for the application B, “0” for the application C “0”, . . . . Therefore, the application combination of “UT1” corresponds to a key “110 . . . ”. Similarly, the user class ID “UT2” corresponds to a key “010 . . . ”, and the user class ID “UT3” corresponds to a key “001 . . . ”.

By applying a hash function HF10 to the key that is derived for each user class as described above, a hash value HT10 is derived. For example, by applying the hash function HF10 to the key “110 . . . ” of the user class ID “UT1”, a hash value “8f36a4bc . . . ” is derived. Similarly, a hash value “52ac5987 . . . ” is derived by applying the hash function HF10 to the key “010 . . . ” of the user class ID “UT2”, and a hash value “4d7f964c . . . ” is derived by applying the hash function HF10 to the key “001 . . . ” of the user class ID “UT3”. In this manner, the key K10 as the application combination treated as a binary value of each user class is converted to the hash value HT10 by the hash function HF10. Incidentally, FIG. 8 and FIG. 9 illustrate examples in which the hash values are represented in a hexadecimal format.

Therefore, as illustrated in FIG. 8, the user class information storage unit 125 stores therein the hash value “8f36a4bc . . . ” for the user class ID “UT1”, the hash value “52ac5987 . . . ” for the user class ID “UT2”, and the hash value “4d7f964c . . . ” for the user class ID “UT3”. By storing the converted hash value as described above, it is possible to improve the security. Further, in the example illustrated in FIG. 8, if the bit number of the hash value HT10 when represented in a binary format is smaller than the bit number of the key K10, it is possible to reduce the amount of data stored in the user class information storage unit 125 as compared to the application combination before conversion.

In this case, the determining unit 133 performs the determination process based on the user class and the hash value stored in the user class information storage unit 125. For example, the determining unit 133 derives a hash value by applying the hash function HF10 even to the list of the applications acquired from the terminal device 10. Incidentally, the list of the applications is information indicating installation or non-installation of each application, and is information, such as a binary value or a hexadecimal value, that can be treated in various formats. For example, in the case of a list of applications including “0” indicating that the application A is not installed, “1” indicating that the application B is installed, “1” indicating that the application C is installed, the application combination may be treated as a binary value “101 . . . ” or a 1-by-x matrix “[011 . . . ]”. Meanwhile, the determining unit 133 derives a hash value by applying the hash function HF10 to the list of the applications treated as a binary value. For example, the determining unit 133 applies the hash function HF10 to the binary value “011 . . . ” of the list of the applications installed in the terminal device 10, and derives a hash value “51c378b2 . . . ”. Then, the determining unit 133 compares the similarity between the hash value of the list of the applications and the hash value HT10 of each user class stored in the user class information storage unit 125, and determines the user class of the user who owns the terminal device 10. For example, the determining unit 133 may appropriately use various clustering methods, such as K-means clustering or cosine similarity. With use of the locality-sensitive hashing method, it is expected that the user who owns the terminal device 10 is determined as corresponding to a user class associated with an application combination similar to the list of the applications of the user.

In the above-described example, the determining unit 133 derives the hash value from the list of the applications. However, the acquiring unit 131 may acquire the hash value from the terminal device 10. That is, the terminal device 10 applies the hash function HF10 to the list of the installed application and derives the hash value. Then, the terminal device 10 transmits the derived hash value to the advertisement distribution apparatus 100. Specifically, at Step S13 in FIG. 1, the terminal device 10 transmits the derived hash value to the advertisement distribution apparatus 100. When the advertisement distribution apparatus 100 acquires the hash value that is converted from the list of the applications from the terminal device 10 as described above, it is possible to improve the protection of privacy and improve the security. Further, if the amount of data is reduced because of the conversion to the hash value, it is possible to reduce a communication load. In this case, the advertisement distribution apparatus 100 may transmit information on the hash function HF10 to the terminal device 10.

4-3. Use of Low-Rank Approximation

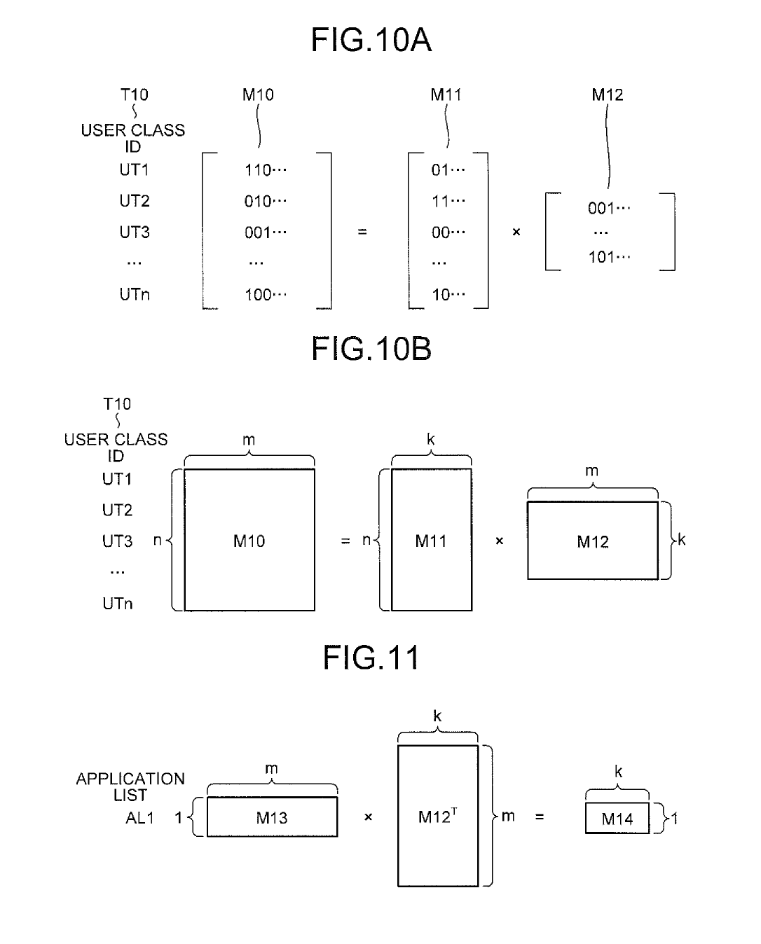

The advertisement distribution apparatus 100 may perform the determination process based on a user class associated with an application combination subjected to low-rank approximation. For example, the advertisement distribution apparatus 100 determines the user class of the user who owns the terminal device 10 by using a plurality of matrices approximated by a matrix indicating association between the user class and the application combination through the low-rank approximation. This will be described below with reference to FIGS. 10A, 10B and 11. FIGS. 10A and 10B are diagrams illustrating an example of the low-rank approximation according to the modification.

As illustrated in FIGS. 10A and 10B, the advertisement distribution apparatus 100 treats the application combinations corresponding to the respective user classes as a single matrix M10 (hereinafter, may be referred to as the “user class matrix M10”). For example, the application combinations of the respective user classes are treated so as to correspond to respective rows of the user class matrix M10. Specifically, the application combination of the user class ID “UT1” corresponds to the first row of the user class matrix M10. That is, in the example illustrated in FIG. 10A, in the user class matrix M10, a value in the first row and the first column is “1”, a value in the first row and the second column is “1”, a value in the first row and the third column is “0”, . . . . Similarly, the application combination of the user class ID “UT2” corresponds to the second row of the user class matrix M10. That is, in the user class matrix M10, a value in the second row and the first column is “0”, a value in the second row and the second column is “1”, a value in the second row and the third column is “0” . . . . Further, the user class ID “UT3” and subsequent user class IDs correspond to the respective rows of the matrix M10 in the same manner. Therefore, it is possible to obtain the user class matrix M10 with components of “0” and “1”.

The low-rank approximation is performed on the user class matrix M10 that is obtained from the application combinations corresponding to the respective user classes as described above. Incidentally, for example, the user class matrix M10 is subjected to matrix factorization that is one of the methods of the low-rank approximation, and factorized into a product of two matrices having lower ranks than the user class matrix M10. Specifically, the user class matrix M10 is subjected to matrix factorization and factorized into a product of two matrices, such as a matrix M11 with a smaller number of columns than the user class matrix M10 (hereinafter, may be referred to as the “first matrix M11”) and a matrix M12 with a smaller number of rows than the user class matrix M10 (hereinafter, may be referred to as the “second matrix M12”). Incidentally, while FIG. 10A illustrates an example in which each of the components of the first matrix M11 and the second matrix M12 is an integer value of “0” or “1”, each of the components of the first matrix M11 and the second matrix M12 may be a real value.

FIG. 10B is a diagram schematically illustrating the matrices M10 to M12. In the example illustrated in FIGS. 10A and 10B, it is assumed that the number of user classes is n, and the number of applications included in each application combination is m. In this case, as illustrated in FIG. 10B, the user class matrix M10 is an n-by-m matrix. The user class matrix M10 is factorized, through the low-rank approximation, into a product of the first matrix M11 with n rows and k columns and the second matrix M12 with k rows and m columns. In the example illustrated in FIGS. 10A and 10B, it is assumed that “m>k”. That is, the user class matrix M10 is factorized into a product of the first matrix M11 and the second matrix M12 having lower ranks than the user class matrix M10. Therefore, by setting the value of k such that the total number of the components of the first matrix M11 and the components of the second matrix M12 becomes smaller than the number of components of the user class matrix M10, it is possible to reduce the amount of data to be stored, as compared to the amount of data before conversion of the application combination. Incidentally, a process of the low-rank approximation is performed by appropriately using a known method, such as nonnegative matrix factorization, and detailed explanation thereof will be omitted.

Incidentally, each of the n rows of the first matrix M11 corresponds to each user class. For example, the user class ID “UT1” corresponds to the first row of the first matrix M11. Similarly, the user class ID “UT2” corresponds to the second row of the first matrix M11. When the low-rank approximation as described above is performed, the determining unit 133 performs the determination process based on the user class corresponding to each row of the first matrix M11. In this case, the user class information storage unit 122 illustrated in FIG. 4 may store each row of the first matrix M11 in association with each user class, for example. Incidentally, it may be possible to store, as binary digits, an application combination corresponding to each row of the first matrix M11 in association with each user class.

Further, each row of the first matrix M11 illustrated in FIGS. 10A and 10B is an application combination corresponding to each user class for which each row of the user class matrix M10 is compressed. Specifically, each row of the user class matrix M10 has m columns, and each row of the first matrix M11 has k (<m) columns. That is, the application combination corresponding to each user class is reduced by m−k. For example, the m components in each row of the user class matrix M10 is changed to the k components in each row of the first matrix M11 such that the (m−k) components are reduced in each row. In this manner, by performing the low-rank approximation, the components of each row in the matrix are compressed. Therefore, even when different versions of the same application are identified as different applications, it is expected that a user who has installed a different version of the application of the user class is determined as being similar to this user class.

In this case, the determining unit 133 performs the determination process based on each row of the first matrix M11 associated with each user class. Therefore, for example, the determining unit 133 converts the list of the installed applications acquired from the terminal device 10 to the same format as each row of the first matrix M11. This will be described below with reference to FIG. 11.

FIG. 11 illustrates an example of conversion of an application list AL1 acquired from the terminal device 10 to the same format as each row of the first matrix M11. As illustrated in FIG. 11, the determining unit 133 treats the application list AL1 acquired from the terminal device 10 as a single user matrix M13 (hereinafter, referred to as the “user matrix M13”). For example, when the application list AL1 acquired from the terminal device 10 includes “0” for the application A, “1” for the application B, “1” for the application C, . . . , the application list AL1 is treated as the user matrix M13 with one row and m columns (for example, a matrix “[011 . . . ]”), in which a value of the first row and the first column is set to “0”, a value of the first row and the second column is set to “1”, a value of the first row and the third column is set to “1”, . . . .

Then, the determining unit 133 calculates a matrix M14 (hereinafter, referred to as a “compressed matrix M14”) by multiplying the user matrix M13 by a transpose matrix M12^{T} of the second matrix M12 illustrated in FIGS. 10A and 10B. In the example illustrated in FIG. 11, the user matrix M13 is a matrix with one row and m columns, and the transpose matrix M12^{T} is a matrix with m rows and k columns. Therefore, when the user matrix M13 is multiplied by the transpose matrix M12^{T}, the compressed matrix M14 with one row and k columns is calculated. In this manner, the number k of the columns of the compressed matrix M14 is the same as the number k of the columns of each row corresponding to each user class in the user class matrix M10 illustrated in FIGS. 10A and 10B. Therefore, the determining unit 133 determines the user class of the user who owns the terminal device 10 by comparing the rows corresponding to the respective user classes between the compressed matrix M14 and the user class matrix M10 illustrated in FIGS. 10A and 105. For example, the determining unit 133 may appropriately use various clustering methods, such as K-means clustering or cosine similarity, when determining the user class of the user.

Incidentally, in the above-described example, the determining unit 133 calculates the compressed matrix M14 by multiplying the user matrix M13 obtained from the applications list AL1 by the transpose matrix M12^{T}. However, the acquiring unit 131 may acquire the compressed matrix M14 from the terminal device 10. That is, the terminal device 10 multiplies the user matrix M13 obtained from the application list AL1 by the transpose matrix M12^{T} to obtain the compressed matrix M14. Then, the terminal device 10 transmits the calculated compressed matrix M14 to the advertisement distribution apparatus 100. Specifically, at Step S13 in FIG. 1, the terminal device 10 transmits the derived compressed matrix M14 to the advertisement distribution apparatus 100. If the advertisement distribution apparatus 100 acquires the compressed matrix M14 from the terminal device 10 as described above, it becomes possible to improve the protection of privacy and improve the security. Further, by transmitting the compressed matrix M14, it is possible to reduce a communication load. In this case, the advertisement distribution apparatus 100 may transmit information on the transpose matrix M12^{T} to the terminal device 10.

Furthermore, the determining unit 133 may perform the low-rank approximation after applying the hash function HF10 to the application combination of each user class, for example. In this case, it becomes possible to further improve the security. Also, it becomes possible to reduce the amount of data to be stored, as compared to the amount of data before conversion of the application combination. Moreover, when each of the components of the first matrix M11 is “0” or “1” for example, the determining unit 133 may use a hash value that is derived by applying the hash function HF10 to an object in which each row of the first matrix M11 is assumed as binary digits. In this case, it becomes possible to improve the security. Also, it becomes possible to reduce the amount of data to be stored, as compared to the amount of data before conversion of the application combination. That is, the determining unit 133 may perform a process using the hash method and a process using the low-rank approximation in combination with each other.

4-4. Others

In the above-described first embodiment, the determining unit 133 determines the user class based on whether or not an application is installed in the terminal device 10. However, it may be possible to determine the user class based on the frequency of use, the time of use, or the like of an installed application. For example, even when an application is installed, if the application is not used for a predetermined period (for example, one month), the determining unit 133 may determine the user class based on the assumption that the application is not installed. Furthermore, the determining unit 133 may determine the user class based on non-installation of a specific application. For example, when a user has not installed an application related to games, and if a certain user class is associated with the field of games as the interested field, the determining unit 133 may not determine that the user corresponds to this user class even if a combination of other applications of this user class has a similarity. Moreover, the advertisement distribution apparatus 100 may distribute an advertising content based on non-installation of a specific application. For example, even when an advertising content related to games is selected based on the user class, the advertisement distribution apparatus 100 may distribute a different advertising content to a user who has not installed an application related to games. Furthermore, the advertisement distribution apparatus 100 may store a behavior history of a user who has used an application by using identifiable information, and the application used by using the identifiable information, in an associated manner. In this case, the advertisement distribution apparatus 100 can grasp that a user who has installed a specific application tends to be interested in, for example, sports on the basis of the behavior history of the user and information on the application used by using the identifiable information. In this case, it is possible to provide a recommendation or the like suitable for the tendency of the user who has installed the specific application.

5. Advantageous Effects

As described above, the advertisement distribution apparatus 100 according to the first embodiment includes the acquiring unit 131 and the determining unit 133. The acquiring unit 131 acquires information on applications installed in the terminal device 10. The determining unit 133 determines a user class of a user who owns the terminal device 10 based on the information on the applications acquired by the acquiring unit 131 and a user class stored in the storage unit 120 (in the embodiment, the user class information storage unit 122) in association with an application combination.

Therefore, the advertisement distribution apparatus 100 according to the first embodiment can appropriately determine the user class of the user.

Furthermore, the advertisement distribution apparatus 100 according to the first embodiment further includes the generating unit 132. The acquiring unit 131, when acquiring information on applications on a user who is identifiable by an information processing apparatus (in the embodiment, the advertisement distribution apparatus 100), associates the acquired information on the applications on the identifiable user with attribute information on the identifiable user, where the attribute information is stored in the storage unit 120 (in the embodiment, the user information storage unit 121). The generating unit 132 generates the user class and the predetermined application combination based on the attribute information and the information on the applications on the identifiable user in the storage unit 120 (in the embodiment, the user information storage unit 121).

Therefore, the advertisement distribution apparatus 100 according to the first embodiment generates the user class and the predetermined application combination based on the attribute information and the information on the applications on the identifiable user, and determines the user class of the user who owns the terminal device 10. Consequently, the user class is determined based on the attribute information, so that the user class of the user can be determined more appropriately.

Moreover, in the advertisement distribution apparatus 100 according to the first embodiment, the acquiring unit 131 acquires, as the attribute information, a behavior history of the identifiable user. The generating unit 132 generates the user class and the predetermined application combination based on the behavior history and the information on the applications on the identifiable user, where the behavior history and the information on the applications are acquired by the acquiring unit 131.

Therefore, the advertisement distribution apparatus 100 according to the first embodiment can estimate a field in which the user who owns the terminal device is likely to be interested, in accordance with the user class based on the behavior history of the user.

Furthermore, in the advertisement distribution apparatus 100 according to the first embodiment, the acquiring unit 131 associates a behavior history of a user who has used an application by using information identifiable by the advertisement distribution apparatus 100, with the application used by using the identifiable information.

Therefore, the advertisement distribution apparatus 100 according to the first embodiment associates the behavior history on the application used by the identifiable user with the application, so that it is possible to estimate a field in which the user who owns the terminal device is likely to be interested.

Moreover, in the advertisement distribution apparatus 100 according to the first embodiment, the generating unit 132 generates the user class associated with an interested field estimated based on the attribute information on the identifiable user.

Therefore, the advertisement distribution apparatus 100 according to the first embodiment associates the user class with the estimated interested field in which the user class may be interested, and determines the user class of the user who owns the terminal device 10, so that it is possible to estimate a field in which the user who owns the terminal device is likely to be interested.

Furthermore, in the advertisement distribution apparatus 100 according to the first embodiment, the determining unit 133 determines the user class of the user who owns the terminal device 10 based on a user class that is associated with, as the predetermined application combination, a combination of application classes for classifying applications.

Therefore, the advertisement distribution apparatus 100 according to the first embodiment uses the combination of application classes for classifying applications, so that it becomes possible to determine that a user who has installed a different application belonging to the same application class in the terminal device 10 belongs to a user class associated with a corresponding combination of application classes. Consequently, it becomes possible to more appropriately determine the user class of the user.

Moreover, in the advertisement distribution apparatus 100 according to the first embodiment, the determining unit 133 determines the user class of the user who owns the terminal device 10 based on a list of applications installed in the terminal device 10, as the information on the applications, and based on the user class.

Therefore, the advertisement distribution apparatus 100 according to the first embodiment determines the user class of the user who owns the terminal device 10 based on the list of the applications installed in the terminal device 10 and based on the user class, so that it is possible to appropriately determine the user class of the user.

Furthermore, in the advertisement distribution apparatus 100 according to the first embodiment, the acquiring unit 131 acquires, as the information on the applications, information indicating installation or non-installation of each of the applications in the terminal device 10. The determining unit 133, when the predetermined application combination is information indicating presence or absence of each of predetermined applications, and if the predetermined application combination is a hash value converted through a predetermined hash method, determines the user class of the user who owns the terminal device 10 based on the user class associated with the hash value and based on a hash value converted from the list of the applications through the predetermined hash method.

Therefore, the advertisement distribution apparatus 100 according to the first embodiment treats the information on the applications as the hash value, so that it becomes possible to improve the protection of privacy, improve the security, and reduce the amount of data. Further, by performing communication using the converted hash value, it becomes possible to further improve the protection of privacy, improve the security, and reduce the amount of data to be transmitted and received.

Moreover, in the advertisement distribution apparatus 100 according to the first embodiment, the determining unit 133, when the predetermined application combination is a hash value converted through a locality-sensitive hashing method, determines the user class of the user who owns the terminal device 10 based on the user class associated with the hash value and based on a hash value converted from the list of the applications through the locality-sensitive hashing method.

Therefore, the advertisement distribution apparatus 100 according to the first embodiment treats the information on the applications as the hash value, so that it becomes possible to improve the protection of privacy, improve the security, and reduce the amount of data. By performing communication using the converted hash value, it becomes possible to further improve the protection of privacy, improve the security, and reduce the amount of data to be transmitted and received. With use of the locality-sensitive hashing method, it is possible to increase the likelihood that the hash values of those corresponding to similar application combinations match each other. Consequently, it becomes possible to more appropriately determine the user class of the user.

Furthermore, in the advertisement distribution apparatus 100 according to the first embodiment, the determining unit 133 determines the user class of the user who owns the terminal device 10 by using a plurality of matrices that are approximated, through low-rank approximation, by a matrix indicating association between the user class and the application combination.

Therefore, the advertisement distribution apparatus 100 according to the first embodiment can improve the security and reduce the amount of data. By performing the low-rank approximation, even when different versions of the same application are identified as different applications, it is expected that a user who has installed a different version of the application of the user class is determined as being similar to the user class.

The advertisement distribution apparatus 100 according to the first embodiment includes the distribution unit 135. The distribution unit 135 distributes a content to the terminal device 10 based on the information on the applications acquired by the acquiring unit 131 and based on an application combination.

Therefore, the advertisement distribution apparatus 100 according to the first embodiment can distribute an appropriate content to the user by distributing the content to the terminal device 10 based on the information on the applications and the application combination.

Furthermore, in the advertisement distribution apparatus 100 according to the first embodiment, the distribution unit 135 distributes, as the content, an advertising content for advertising.

Therefore, the advertisement distribution apparatus 100 according to the first embodiment distributes the content to the terminal device 10 based on the information on the applications and the application combination, so that is possible to distribute an appropriate content to the user.

### Second Embodiment

As described above in the first embodiment, in the distribution system 1, the advertisement distribution apparatus 100 performs the determination process and distributes an advertising content based on the determined user class. In contrast, in a second embodiment, a distribution system 2 will be described, in which a terminal device 11 owned by a user performs the determination process, transmits information on the determined user class to an advertising apparatus 30, and receives distribution of an advertising content based on the user class from the advertising apparatus 30.

1. Distribution Process

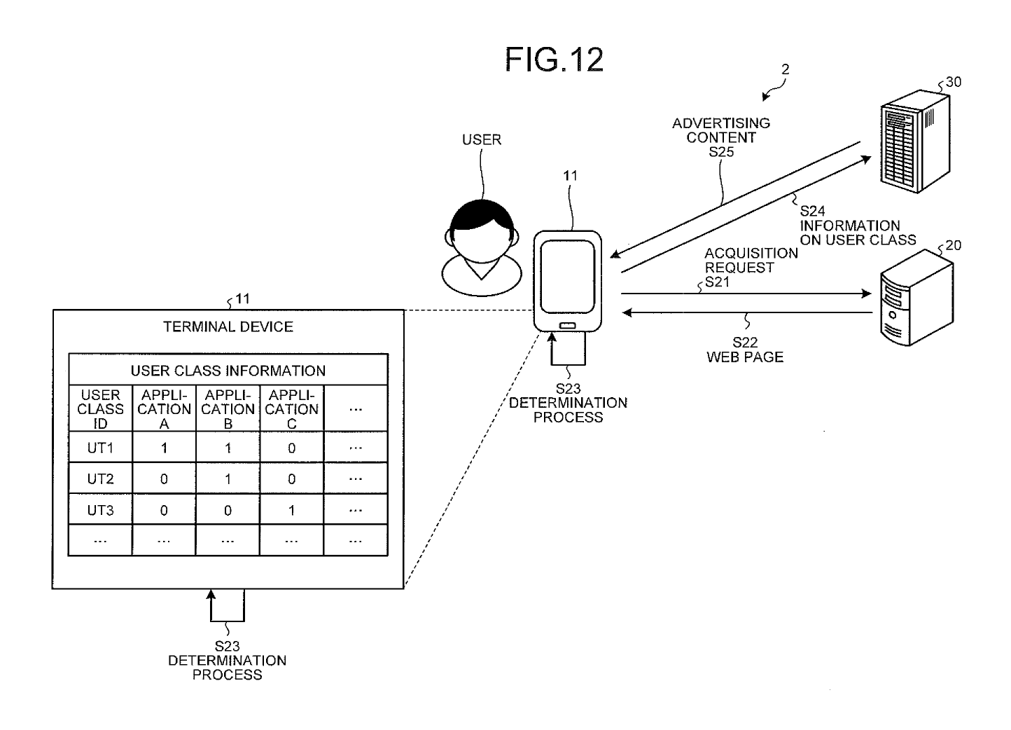

First, with reference to FIG. 12, an example of a distribution process according to the second embodiment will be described. FIG. 12 is a diagram illustrating an example of the distribution process according to the second embodiment. The terminal device 11 illustrated in FIG. 12 transmits information on a user class that is determined based on a list of installed application to the advertising apparatus 30, and receives an advertising content distributed from the advertising apparatus 30.

As illustrated in FIG. 12, the distribution system 2 includes the terminal device 11, the web server 20, and the advertising apparatus 30. The terminal device 11, the web server 20, and the advertising apparatus 30 are connected through a predetermined communication network (not illustrated) so as to communicate with one another by wire or wirelessly. The distribution system 2 illustrated in FIG. 12 may include a plurality of the terminal devices 11, a plurality of the web servers 20, and a plurality of the advertising apparatuses 30. The web server 20 according to the second embodiment is the same as the web server 20 according to the first embodiment, and therefore, explanation thereof will be omitted.

The terminal device 11 is an information processing apparatus used by a user. For example, the terminal device 11 acquires a web page from the web server 20 in accordance with an operation by the user. In the following, the terminal device 11 may be described as a user. That is, in the following, a user may be interpreted as the terminal device 11. The terminal device 11 as described above is realized by, for example, a smartphone, a tablet terminal, a notebook PC, a desktop PC, a mobile phone, PDA, or the like. The terminal device 11 performs a determination process of determining a user class of the user who owns the terminal device 11, on the basis of a list of applications installed in the terminal device 11 and a user class associated with an application combination included in user class information, which will be described in detail later.

The advertising apparatus 30 distributes, to the terminal device 11, an advertising content selected based on information on the user class received from the terminal device 11. For example, the advertising apparatus 30 receives, as the information on the user class, an interested field of the user class from the terminal device 11, and distributes an advertising content selected based on the interested field of the user class to the terminal device 11. Therefore, the advertising apparatus 30 distributes an advertising content in which it is estimated that the user who owns the terminal device 11 is likely to be interested, in accordance with the received interested field. The advertising apparatus 30 includes an advertising content storage unit that stores therein the same information as the information stored in the advertising content storage unit 123 illustrated in FIG. 5.

As illustrated in FIG. 12, when the user views a web page by using the terminal device 11, the terminal device 11 transmits a web page acquisition request to the web server 20 (Step S21). The web server 20 that has received the web page acquisition request from the terminal device 11 distributes, to the terminal device 11, a web page corresponding to the acquisition request received from the terminal device 11 (Step S22).

If the web page contains an advertising acquisition command, the terminal device 11 that has received the web page from the web server 20 performs the determination process of determining the user class of the user who owns the terminal device 11 (Step S23). Thereafter, the terminal device 11 transmits information on the user class determined through the determination process to the advertising apparatus 30 (Step S24). For example, the terminal device 11 transmits, as the information on the user class, an interested field of the user class to the advertising apparatus 30.

The advertising apparatus 30 that has received the information on the user class from the terminal device 11 selects an advertising content based on the received information on the user class, and distributes the selected advertising content to the terminal device 11 (Step S25). For example, if the interested field received as the information on the user class is the field of vehicles, the advertising apparatus 30 distributes an advertising content related to a vehicle to the terminal device 11.

As described above, in the distribution system 2 according to the second embodiment, the terminal device 11 determines the user class of the user who owns the terminal device 11 on the basis of the user class information and the list of the installed applications. Therefore, the terminal device 11 can appropriately determine the user class of the user. The terminal device 11 transmits information on the determined user class to the advertising apparatus 30 to request distribution of an advertising content. The advertising apparatus 30 that has received the information on the user class distributes an advertising content selected based on the user class to the terminal device 11. Therefore, the terminal device 11 can receive distribution of an advertising content in which the user who owns the terminal device 11 is likely to be interested. In other words, the terminal device 11 can receive distribution of an advertising content suitable for the user who is the owner thereof; therefore, it is possible to improve the advertising effect. In this manner, the user who owns the terminal device 11 can receive an appropriate service based on the list of the applications installed in the terminal device 11, without transmitting a user's behavior history, profile, or list of applications to the outside. That is, the distribution system 2 including the terminal device 11 can perform advertising distribution and product recommendation (recommendation) suitable for a user even when a behavior history, profile information, or the like on the user is not acquired. Therefore, it is possible to address a problem (so-called cold start problem) in that it is difficult to appropriately perform advertising distribution and recommendation suitable for a user whose behavior history or profile information is not acquired. That is, the distribution system 2 can appropriately provide various services, such as advertising distribution and recommendation, to the user based on the list of the applications of the terminal device 11, without causing the user to transmit the behavior history or the profile from the terminal device 11 of the user. Further, for example, when the user class and the application combination of the user class information are generated based on the information on the applications acquired from a user who has logged in a predetermined service or a user who has accepted collection of a behavior history, it is possible to obtain a user class modeled based on the facts such as the behaviors of the user. Therefore, it is possible to estimate a behavioral tendency of the user who is classified based on the user class as described above, in such a manner that, for example, the user is likely to be interested in a content Y because the user has installed a predetermined application X. That is, when the user class is determined based on the user class modeled based on the behavior history, the user who owns the terminal device 11 can receive a recommendation based on a behavior history of a person similar to the user. Therefore, the user who owns the terminal device 11 can receive a recommendation suitable for the user without transmitting the user's behavior history to the outside.

Incidentally, if the advertising apparatus 30 has information on association between the user class and the interested field of the user class, the terminal device 11 may transmit the user class to the advertising apparatus 30. In this case, the terminal device 11 transmits the user class of the user determined through the determination process to the advertising apparatus 30. Then, the advertising apparatus 30 that has received the user class distributes, to the terminal device 11, an advertising content corresponding to a distribution condition including the interested field of the received user class, for example.

2. Configuration of Terminal Device

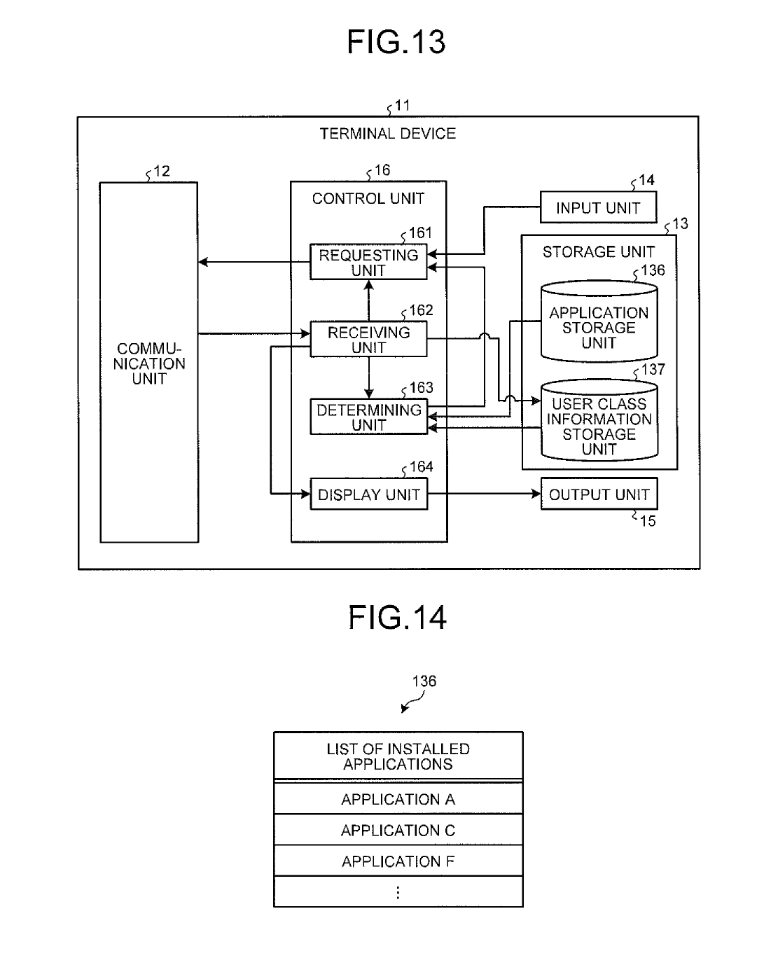

Next, with reference to FIG. 13, a configuration of the terminal device 11 according to the second embodiment will be described. FIG. 13 is a diagram illustrating a configuration example of the terminal device 11 according to the second embodiment. As illustrated in FIG. 13, the terminal device 11 includes a communication unit 12, a storage unit 13, an input unit 14, an output unit 15, and a control unit 16.

Communication Unit 12

The communication unit 12 is realized by, for example, a communication circuit or the like. The communication unit 12 is connected to a predetermined communication network (not illustrated) by wire or wirelessly, and transmits and receives information to and from the web server 20 and the advertising apparatus 30.

Storage Unit 13

The storage unit 13 is realized by, for example, a semiconductor memory device such as a RAM or a flash memory, or a storage device such as a hard disk or an optical disk. The storage unit 13 according to the second embodiment includes, as illustrated in FIG. 13, an application storage unit 136 and a user class information storage unit 137.

Application Storage Unit 136

The application storage unit 136 according to the second embodiment stores therein information on applications installed in the terminal device 11. FIG. 14 illustrates an example of information on applications stored in the application storage unit 136. As illustrated in FIG. 14, the application storage unit 136 stores therein, as the information on applications, an item of “list of installed applications”.

The “list of installed applications” indicates applications installed in the terminal device 11. In the example illustrated in FIG. 14, the application storage unit 136 indicates that applications such as an “application A”, an “application C”, an “application F”, are installed in the terminal device 11. The application storage unit 136 may store therein, as an ID, a hash value that is converted from an application process name through a predetermined hash function. Further, when the determination process is performed by using, as the installed applications, applications that can be acquired from processes by the terminal device 11, the application storage unit 136 may not be provided.

User Class Information Storage Unit 137

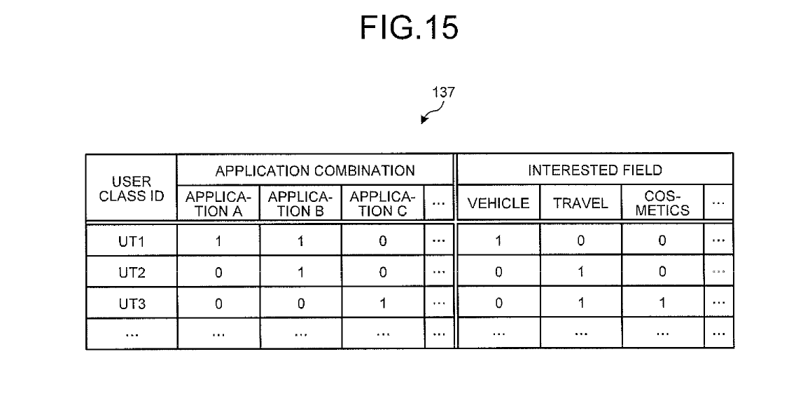

The user class information storage unit 137 according to the second embodiment stores therein information on the user class. FIG. 15 illustrates an example of the information on the user class stored in the user class information storage unit 137. As illustrated in FIG. 15, the user class information storage unit 137 includes, as the information on the user class, items of “user class ID”, “application combination”, and “interested field”.

The “user class ID” indicates identification information for identifying a plurality of user classes for classifying users. For example, the user class ID indicates identification information for identifying a plurality of user classes for classifying users based on application combinations. In the example illustrated in FIG. 15, a user class identified by the user class ID “UT1” is a user class of a user whose interested field corresponds to the field of vehicles and the like, a user class identified by the user class ID “UT2” is a user class of a user whose interested field corresponds to the field of travel and the like, a user class identified by the user class ID “UT3” is a user class of a user whose interested field corresponds to the field of travel, the field of cosmetics, and the like, . . . .

The “application combination” indicates information on whether or not a predetermined application is installed in a terminal device of a user belonging to the user class identified by the user class ID. The “application combination” includes items of “application A”, “application B”, “application C”, Herein, each of the “application A”, the “application B”, the “application C”, . . . corresponds to a specific application. For example, the “application A” is a specific game application, the “application B” is a specific news application, and the “application C” is a specific mail-order application. Therefore, the user class information storage unit 137 stores therein a plurality of user classes for classifying users and a plurality of specific application combinations in an associated manner.

The “application A” indicates whether or not the application A is installed. For example, the user class information storage unit 137 stores therein “1” when the application A is installed, and stores therein “0” when the application A is not installed. In the example illustrated in FIG. 15, a user class identified by the user class ID “UT1” has installed the application A, and user classes identified by the user class ID “UT2” and the user class ID “UT3” have not installed the application A. In other words, users with the user class ID “UT1” are likely to have installed the application A, and users with the user class ID “UT2” and the user class ID “UT3” are less likely to have installed the application A.

The “application B” indicates whether or not the application B is installed. For example, the user class information storage unit 137 stores therein “1” when the application B is installed, and stores therein “0” when the application B is not installed. In the example illustrated in FIG. 15, the user classes identified by the user class ID “UT1” and the user class ID “UT2” have installed the application B, and the user class identified by the user class ID “UT3” has not installed the application B.

Similarly, the “application C” indicates whether or not the application C is installed. For example, the user class information storage unit 137 stores therein “1” when the application C is installed, and stores therein “0” when the application C is not installed. In the example illustrated in FIG. 15, the user classes identified by the user class ID “UT1” and the user class ID “UT2” have not installed the application C, and the user class identified by the user class ID “UT3” has installed the application C.

Incidentally, in the “interested field”, information on an interested field of the user class identified by the user class ID is stored. The “interested field” includes items of “vehicle”, “travel”, “cosmetics”, . . . . For example, it may be possible to store “1” for a field in which it is estimated that a user belonging to the user class identified by the user class ID is likely to be interested, and store “0” for other fields. In the example illustrated in FIG. 15, in the user class information storage unit 137, “1” is set for “vehicle”, “0” is set for “travel”, “0” is set for “cosmetics”, . . . for a user belonging to the user class identified by the user class ID of “UT1”. That is, the user class information storage unit 137 stores information indicating that a user belonging to the user class identified by the user class ID “UT1” is interested in vehicles but is not interested in travel and cosmetics.

Input Unit 14

The input unit 14 receives various operations from a user. For example, the input unit 14 may receive various operations from the user through a display screen of a touch panel function. Further, the input unit 14 may receive various operations from a button provided on the terminal device 11 or from a keyboard or a mouse connected to the terminal device 11.

Output Unit 15

The output unit 15 is a display screen of a tablet terminal or the like realized by, for example, a liquid crystal display, an organic electro-luminescence (EL) display, or the like, and is a display device for displaying various kinds of information.

Control Unit 16

The control unit 16 is realized, for example, by executing various programs (corresponding to an example of a display program) stored in a storage device, such as the storage unit 13, in the terminal device 11 by a CPU, an MPU, or the like by using a RAM as a work area. For example, the various programs corresponds to application programs called web browsers. Further, the control unit 16 is realized by an integrated circuit, such as an ASIC or an FPGA.

As illustrated in FIG. 13, the control unit 16 includes a requesting unit 161, a receiving unit 162, a determining unit 163, and a display unit 164, and realizes or implements functions and operations of a distribution process as described below. The internal configuration of the control unit 16 is not limited to the configuration illustrated in FIG. 13, and other configurations may be employed as long as the distribution process to be described later is performed. Further, the connection relation of the processing units of the control unit 16 is not limited to the connection relation illustrated in FIG. 13, and other connection relations may be employed.

The requesting unit 161 transmits a web page acquisition request to the web server 20 in accordance with a user operation received by the input unit 14. When a web page received by the receiving unit 162 contains an advertising acquisition command, the requesting unit 161 transmits the information on the user class determined through the determination process to the advertising apparatus 30.

The receiving unit 162 receives a web page and an advertising content. Specifically, the receiving unit 162 receives a web page from the web server 20 in response to the web page acquisition request transmitted by the requesting unit 161. At this time, when the web page contains the advertising acquisition command, the receiving unit 162 gives an instruction to perform the determination process to the determining unit 163. When receiving the user class information, the receiving unit 162 stores it in the user class information storage unit 137.

When receiving the instruction to perform the determination process from the receiving unit 162, the determining unit 163 determines the user class of the user who owns the terminal device 11 based on the list of the applications installed in the terminal device 11 and based on the user class information. Specifically, the determining unit 163 performs the process of determining the user class of the user who owns the terminal device 11 based on the list of the applications stored in the application storage unit 136 and the user class information stored in the user class information storage unit 137.

In this manner, the determining unit 163 performs the determination process of determining the user class of the user who owns the terminal device 11 based on the list of the applications installed in the terminal device 11 and the user class information. The determination process will be described in detail below.

For example, when there is a user class for which the list of the applications stored in the application storage unit 136 and the application combination match each other, the determining unit 163 determines that the user who owns the terminal device 11 corresponds to this user class. Specifically, when the list of the applications stored in the application storage unit 136 and the application combination of the user class ID “UT1” match each other, the determining unit 163 may determine that the user who owns the terminal device 11 corresponds to the user class ID “UT1”. Herein, match between the list of the applications and the application combination means that, for example, an array of “0” and “1” in the list of the applications and an array of “0” and “1” in the application combination are the same. Incidentally, in this case, the list of the applications and the application combination are arrays of pieces of information indicating installation or non-installation of applications in the same order, for example, in order of the “application A”, the “application B”, the “application C”, . . . . That is, the list of the applications and the application combination have the same information of “0” (or “1”) as to installation or non-installation of the same application, and do not include an application whose value is different.

Further, the determining unit 163 may determine that the user who owns the terminal device 11 belongs to a user class for which the list of the applications and the application combination most closely approximate each other. Herein, the closest approximation between the list of the applications and the application combination means that, for example, the number of differences between the array of “0” and “1” in the list of the applications and the array of “0” and “1” in the application combination is small. Specifically, the determining unit 163 may determine that they more closely approximate each other when the total number of portions in each of which “0” is set in the list of the applications while “1” is set in the application combination and portions in each of which “1” is set in the list of the applications while “0” is set in the application combination, is smaller (that is, the number of portions in which different values are set for the same applications is smaller). Therefore, the determining unit 163 may determine that the user who owns the terminal device 11 belongs to a user class corresponding to the application combination for which the above-described total number is the smallest. Incidentally, the determining unit 163 may determine that the user who owns the terminal device 11 belongs to a plurality of user classes.

The determining unit 163 sends, to the requesting unit 161, the information on the user class of the user who owns the terminal device 11, where the user class is determined through the determination process. Specifically, the determining unit 163 sends, as the information on the user class, the interested field of the user class to the requesting unit 161.

The requesting unit 161 that has received the interested field of the user class from the determining unit 163 transmits the interested field of the user class to the advertising apparatus 30. Thereafter, the receiving unit 162 receives an advertising content from the advertising apparatus 30. The receiving unit 162 that has received the advertising content sends the received advertising content to the display unit 164.

The display unit 164 displays, on the output unit 15, the web page and the advertising content received by the receiving unit 162. For example, the display unit 164 displays the advertising content in an advertisement display area that is a part of a display area of the web page.

Incidentally, the above-described distribution process performed by the control unit 16 may be realized by, for example, JavaScript (registered trademark) or the like. Further, when the above-described distribution process is performed by a predetermined application or when the determination process is performed by a special application, the control unit 16 may include, for example, an application control unit that controls the predetermined application or the special application.

3. Flow of Distribution Process

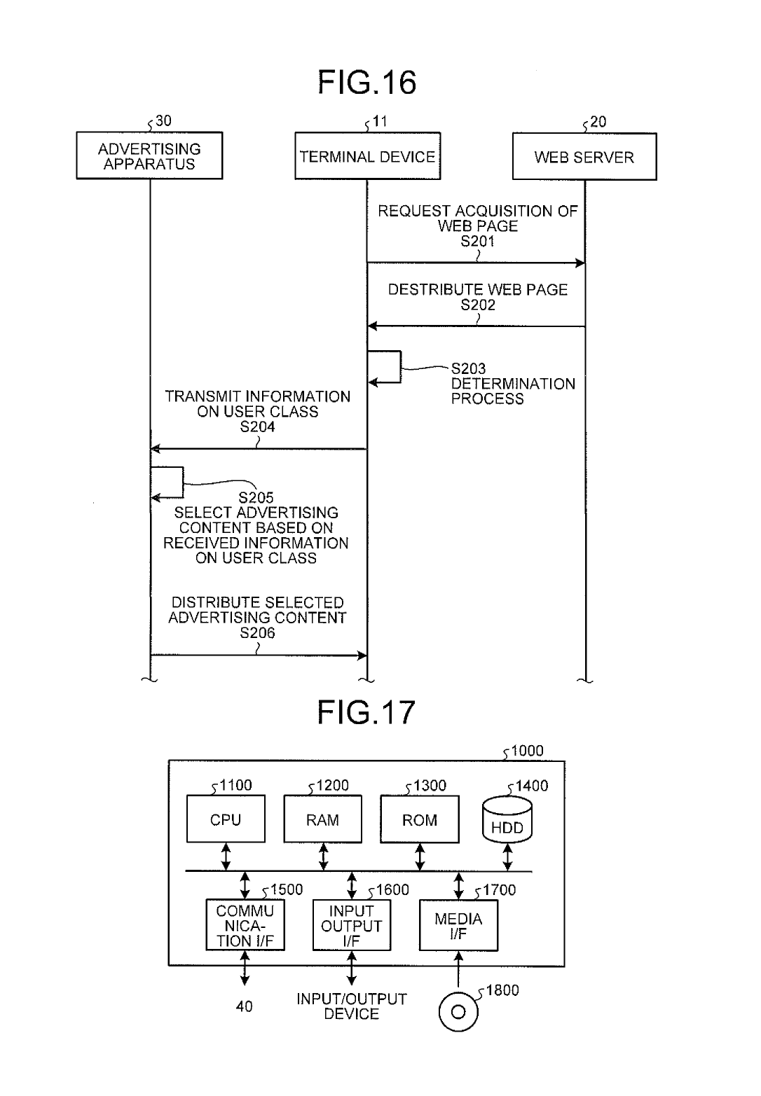

Next, with reference to FIG. 16, the flow of the distribution process performed by the distribution system 2 according to the second embodiment will be described. FIG. 16 is a sequence diagram illustrating the flow of the distribution process performed by the distribution system 2 according to the second embodiment.

As illustrated in FIG. 16, the terminal device 11 transmits a web page acquisition request to the web server 20 in accordance with a user operation (Step S201). The web server 20 distributes a web page to the terminal device 11 in response to the web page acquisition request (Step S202). The web page distributed by the web server 20 includes an advertising acquisition command, such as a URL of the advertising apparatus 30.

Subsequently, when the web page contains the advertising acquisition command, the terminal device 11 performs the determination process of determining the user class of the user who owns the terminal device 11 (Step S203). Thereafter, the terminal device 11 transmits information on the user class to the advertising apparatus 30 (Step S204). Specifically, the terminal device 11 transmits, as the information on the user class, an interested field of the user class to the advertising apparatus 30. Then, the advertising apparatus 30 selects an advertising content based on the received interested field that is the information on the user class (Step S205). Thereafter, the advertising apparatus 30 distributes the selected advertising content to the terminal device 11 (Step S206).

4. Others

In the above-described second embodiment, the terminal device 11 determines the user class based on whether or not a specific application is installed. However, it may be possible to determine the user class based on whether or not an application belonging to an application class for classifying applications. In this case, the user class information storage unit 137 of the storage unit 13 stores therein the same information as the information stored in the user class information storage unit 124 illustrated in FIG. 7. Further, the terminal device 11 may determine the user class based on the frequency of use, the time of use, or the like of an application installed in the terminal device 11. For example, even when an application is installed, if the application is not used for a predetermined period (for example, one month), the terminal device 11 may determine the user class based on the assumption that the application is not installed (for example, not stored in the application storage unit 136). Further, the terminal device 11 may determine the user class based on non-installation of a specific application. For example, when a user has not installed an application related to fashion, and if a certain user class is associated with the field of fashion as the interested field, the terminal device 11 may not determine that the user corresponds to this user class even if a combination of other applications of this user class has a similarity.

5. Advantageous Effect

As described above, the terminal device 11 according to the second embodiment includes the application storage unit 136 and the determining unit 163. The application storage unit 136 stores therein the information on the applications installed in the terminal device 11. The determining unit 163 determines the user class of the user who owns the terminal device 11 based on the information on the applications stored in the application storage unit 136 and the user class associated with a predetermined application combination.

Therefore, the terminal device 11 according to the second embodiment can appropriately determine the user class of the user. Further, because the terminal device 11 determines the user class of the user, it is possible to determine the user class while retaining the list of the applications inside the terminal device 11. Therefore, it is possible to improve the protection of privacy, improve the security, and reduce the amount of data.

The terminal device 11 according to the second embodiment further includes the requesting unit 161. The requesting unit 161 transmits the information on the user class to the information processing apparatus to request distribution of a content.

Therefore, the terminal device 11 according to the second embodiment transmits, as the information on the user class of the user, the interested field to the advertising apparatus 30, and receives distribution of an advertising content selected based on the interested field of the user class from the advertising apparatus 30. Therefore, it is possible to receive an advertising content suitable for the user.

### First and Second Embodiments

### 1. Configuration of Apparatus

The advertisement distribution apparatus 100 illustrated in FIG. 2 may not include the user information storage unit 121, the user class information storage unit 122, or the advertising content storage unit 123. Specifically, the advertisement distribution apparatus 100 may be connected to a database server including the user information storage unit 121, the user class information storage unit 122, or the advertising content storage unit 123. The distribution process according to the first embodiment may be performed by a determination apparatus that determines the user class and a distribution apparatus that distributes an advertising content in cooperation with each other.

2. Program

The advertisement distribution apparatus 100 according to the above-described first embodiment is realized by a computer 1000 configured as illustrated in FIG. 17, for example. FIG. 17 is a hardware configuration diagram illustrating an example of the computer 1000 that implements the functions of the advertisement distribution apparatus 100. The computer 1000 includes a CPU 1100, a RAM 1200, a ROM 1300, an HDD 1400, a communication interface (I/F) 1500, an input output interface (I/F) 1600, and a media interface (I/F) 1700.

The CPU 1100 operates based on a program stored in the ROM 1300 or the HDD 1400, and controls each unit. The ROM 1300 stores therein a boot program executed by the CPU 1100 when the computer 1000 is activated, a program depending on the hardware of the computer 1000, and the like.

The HDD 1400 stores therein the program executed by the CPU 1100, data used by the program, and the like. The communication interface 1500 receives data from other apparatuses through a communication network 40, sends data to the CPU 1100, and transmits data generated by the CPU 1100 to other apparatuses through the communication network 40.

The CPU 1100 controls an output device, such as a display or a printer, and controls an input device, such as a keyboard or a mouse, through the input output interface 1600. The CPU 1100 acquires data from the input device through the input output interface 1600. The CPU 1100 outputs generated data to the output device through the input output interface 1600.

The media interface 1700 reads a program or data stored in a recording medium 1800, and provides it to the CPU 1100 through the RAM 1200. The CPU 1100 loads the program from the recording medium 1800 onto the RAM 1200 through the media interface 1700, and executes the loaded program. The recording medium 1800 is, for example, an optical recording medium such as a digital versatile disc (DVD) or a phase change rewritable disk (PD), a magneto-optical recording medium such as magneto-optical (MO) disk, a tape medium, a magnetic recording medium, a semiconductor memory, or the like.

For example, when the computer 1000 functions as the advertisement distribution apparatus 100 according to the embodiment, the CPU 1100 of the computer 1000 executes the program loaded on the RAM 1200, and implements the functions of the control unit 130. Further, the HDD 1400 stores therein data included in the user class information storage unit 122 and the advertising content storage unit 123. The CPU 1100 of the computer 1000 reads the program from the recording medium 1800 and executes the program. As another example, it may be possible to acquire the program form other apparatuses through the communication network 40.

3. Others

Of the processes described in the embodiments, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in the drawings are not limited to those illustrated in the drawings.

The components of the devices illustrated in the drawings are functionally conceptual and do not necessarily have to be physically configured in the manner illustrated in the drawings. That is, specific forms of distribution and integration of the devices are not limited to those illustrated in the drawings, and all or part of the devices may be functionally or physically distributed or integrated in arbitrary units depending on various loads or use conditions. For example, the acquiring unit 131 and the distribution unit 135 illustrated in FIG. 2 may be integrated with each other.

The above-described embodiments may be combined appropriately as long as the processing contents do not conflict with each other.

While the embodiments of the present invention have been explained in detail above based on the drawings, the embodiments are described by way of example, and the disclosed technologies may be embodied in various other forms with various changes or modifications based on knowledge of person having ordinary skill in the art, in addition to the embodiments described in this specification.

Furthermore, “section, module, or unit” described above may be interpreted as “means,” “circuit,” or the like. For example, the acquiring unit may be interpreted as an acquiring means or an acquiring circuit.

According to an embodiment, it is possible to appropriately determine the user class of the user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an acquiring unit configured to acquire information on applications installed in a terminal device; and
a determining unit configured to determine a user class of a user who owns the terminal device based on the information on the application acquired by the acquiring unit and a user class stored in a storage unit in association with a predetermined application combination.

2. The information processing apparatus according to claim 1, further comprising:
a generating unit configured to generate the user class, wherein
the acquiring unit, when acquiring information on applications on a user who is identifiable by the information processing apparatus, associates the acquired information on the applications with attribute information on the identifiable user, the attribute information being stored in the storage unit, and
the generating unit generates the user class and the predetermined application combination based on the attribute information and the information on the applications on the identifiable user in the storage unit.

3. The information processing apparatus according to claim 2, wherein
the acquiring unit acquires, as the attribute information, a behavior history of the identifiable user, and
the generating unit generates the user class and the predetermined application combination based on the behavior history acquired by the acquiring unit and the information on the applications on the identifiable user.

4. The information processing apparatus according to claim 3, wherein the acquiring unit associates a behavior history of a user who has used an application by using information identifiable by the information processing apparatus, with the application used by using the identifiable information.

5. The information processing apparatus according to claim 2, wherein the generating unit generates the user class associated with an interested field estimated from the attribute information on the identifiable user.

6. The information processing apparatus according to claim 1, wherein the determining unit determines the user class of the user who owns the terminal device based on a user class that is associated with, as the predetermined application combination, a combination of application classes for classifying applications.

7. The information processing apparatus according to claim 1, wherein the determining unit determines the user class of the user who owns the terminal device, based on a list of applications installed in the terminal device, as the information on the applications, and based on the user class.

8. The information processing apparatus according to claim 7, wherein
the acquiring unit acquires, as the information on the applications, information indicating installation or non-installation of each of the applications installed in the terminal device, and
the determining unit, when the predetermined application combination is information indicating presence or absence of each of predetermined applications, and if the predetermined application combination is a hash value converted through a predetermined hash method, determines the user class of the user who owns the terminal device based on the user class associated with the hash value and based on a hash value converted from the list of the applications through the predetermined hash method.

9. The information processing apparatus according to claim 8, wherein the determining unit, when the predetermined application combination is a hash value converted through a locality-sensitive hashing method, determines the user class of the user who owns the terminal device based on the user class associated with the hash value and based on a hash value converted from the list of the applications through the locality-sensitive hashing method.

10. The information processing apparatus according to claim 1, wherein the determining unit determines the user class of the user who owns the terminal device by using a plurality of matrices that are approximated, through low-rank approximation, by a matrix indicating association between the user class and the predetermined application combination.

11. An information processing apparatus comprising:
an acquiring unit configured to acquire, from a terminal device, information on applications installed in the terminal device; and
a distribution unit configured to distribute a content to the terminal device based on the information on the applications acquired by the acquiring unit and based on an application combination.

12. The information processing apparatus according to claim 11, wherein the distribution unit distributes, as the content, an advertising content for advertising.

13. A terminal device comprising:
an application storage unit configured to store information on an application installed in the terminal device; and
a determining unit configured to determine a user class of a user who owns the terminal device, based on the information on the application stored in the application storage unit, and based on a user class associated with a predetermined application combination.

14. The terminal device according to claim 13, further comprising a requesting unit configured to request distribution of a content by transmitting information on the user class to the information processing apparatus.

15. An information processing method implemented by a computer, comprising;
acquiring information on an application installed in a terminal device; and
determining a user class of a user who owns the terminal device, based on the information on application acquired at the acquiring, and based on a user class stored in a storage unit in association with a predetermined application combination.

16. A non-transitory computer-readable storage medium with an executable program stored thereon, wherein the program instructs a computer to perform:
acquiring information on an application installed in a terminal device; and
determining a user class of a user who owns the terminal device, based on the information on application acquired at the acquiring, and based on a user class stored in a storage unit in association with a predetermined application combination.
